(19) United States
(12) Patent Application Publication
(10) Pub. No.: US 2024/0065924 A1
(43) Pub. Date: Feb. 29, 2024

(54) MASSAGE DEVICE

(71) Applicant: Vee International, Inc., Garden City, NY (US)

(72) Inventors: Eric Lee, Dix Hills, NY (US); Jinlv Chen, Dongguan City (CN); David L. Rawlings, Sound Beach, NY (US)

(21) Appl. No.: 18/238,757

(22) Filed: Aug. 28, 2023

Related U.S. Application Data
(60) Provisional application No. 63/401,816, filed on Aug. 29, 2022.

(51) Int. Cl. A61H 7/00; A61H 19/00; A61H 23/02

(52) U.S. Cl. CPC A61H 7/005; A61H 19/44; A61H 23/02; A61H 2201/1215; A61H 2201/149; A61H 2201/1664

(57) ABSTRACT

A massage device includes a drive motor, a drive wheel operatively coupled to the drive motor to rotate upon energization of the drive motor, the drive wheel having an eccentric post situated thereon, a movable bracket that includes one or more massaging elements rotatably mounted on the bracket, a rotational movement-to-linear movement translation coupler operatively coupled to the drive wheel and to the movable bracket, and an exterior sleeve defining a handle for a user to hold the massage device. When the drive motor is energized, the drive motor causes the drive wheel to rotate, the rotating drive wheel causing the movable frame and the one or more massaging elements to move with a linear, reciprocating motion.

### CROSS-REFERENCE TO RELATED APPLICATIONS

This application is related to U.S. Provisional Application Ser. No. 63/401,816, filed on Aug. 29, 2022, and titled “Massage Device Having Lateral Motion”, the disclosure of which is incorporated herein by reference and on which priority is hereby claimed.

### BACKGROUND OF THE INVENTION

### Field of the Invention

The present invention relates to a massage device exhibiting a lateral stimulating motion for personal female use in causing sexual arousal.

### Description of the Related Art

Massage devices for use by females are readily available in the marketplace. These devices vary considerably in all aspects of appearance including geometry, size, function, and color. They also vary widely in price to the consumer.

Demand for these devices is considerable and there are numerous manufacturers engaged in their production. There is robust competition to secure favored reception by this market segment through offers of new functionality and novel cosmetic appearances. Accordingly, there is a very large variety of these devices available and new versions are being offered constantly.

Certain of these devices incorporate internal mechanisms for purposes of providing motion. Such devices rely on the user to manipulate and provide whatever massage motion is desired. The vast majority of devices having motorized mechanisms inside produce a vibratory stimulating motion. Other motions produced are confined within the device envelope and cause wave motion to the surface of the device that may be axial or radial in direction.

It is desirable to create a personal massage device having an entirely different motion from that seen in existing devices. The desired motion has been determined to be a relatively slow back-and-forth movement of extended fingers which are positioned by the user as desired.

The above-mentioned prior art in this field (vibration, wave motions) requires no external device stabilization. Vibration uses the inherent inertia of a device to impart the motion to that area of stimulation selected. Typically, a rapidly spinning motor shaft with an eccentric weight attached thereto creates the vibration. In such conventional massage devices, the mass inertia of the motor and other components such as a battery provides a sort of stable platform from which the vibration can be transmitted to soft tissue outside the device. Alternatively, vibratory motion uses an electromagnetic device driven by a suitable oscillator circuit to create the vibration.

The novel concept of employing a side-to-side, relatively slow, stroking massage motion presents the problem of stabilization. Unlike present devices of this sort, this new design is unable to take advantage of an independent platform created by inherent inertia. A small amount of inertia is satisfactory for stabilization against rapid motion such as vibration and having frequencies above approximately 30 Hz. The contemplated design has a motion frequency below 30 Hz and as low as 1 Hz. Accordingly, some means other than inertia needs to be provided for device stabilization.

The inventors of this device are unaware of any previous attempts to provide the novel attributes contemplated by this invention.

### OBJECTS AND SUMMARY OF THE INVENTION

It is an object of the present invention to provide a massage device that provides a side-to-side, relatively slow, stroking massage motion.

It is another object of the present invention to provide a massage device that addresses all of the design demands outlined above, including stabilization.

In accordance with one embodiment of the present invention, the massage device is a generally cylindrically shaped object with an upper body of essentially rigid construction and a lower portion flexibly connected to the upper body in such a way that the lower portion can move with respect to the upper body. The upper body is configured to allow it to be held comfortably in the user's hand and contains various mechanical components including batteries, motor and linkages. A lower portion includes a generally downward facing element approximately shaped to mimic the form of several extended fingers of a human hand.

Side-to-side (i.e., lateral) motion of the downward facing element is created by use of several alternate novel designs as will be made clear in the descriptions below.

In yet another form of the present invention, a massage device includes a drive motor and a drive wheel operatively coupled to the drive motor to rotate upon energization of the drive motor. The drive wheel includes an eccentric post situated thereon. The massage device in this embodiment further includes a movable bracket. The movable bracket includes one or more massaging elements that are rotatably mounted on the bracket.

The massage device in accordance with this embodiment of the present invention further includes a rotational movement-to-linear movement translation coupler. The rotational movement-to-linear movement translation coupler is operatively coupled to the drive wheel and to the movable bracket. The massage device of this embodiment further includes an exterior sleeve that defines a handle for a user to hold the massage device. The exterior sleeve further defines an interior space in which the drive motor, drive wheel, movable bracket and rotational movement-to-linear movement translation coupler are disposed.

When the drive motor of the massage device of this embodiment of the present invention is energized, the drive motor, being operatively coupled to the drive wheel, causes the drive wheel to rotate. The rotating drive wheel, being operatively coupled to the rotational movement-to-linear movement translation coupler, causes the movable frame and the one or more massaging elements to move with a linear, reciprocating massaging motion which may be applied to the skin or body part of the user.

A preferred form of the massage device, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is an isometric view of a massage device constructed in accordance with a first form of the present invention.

FIG. 2 is an exploded view of the massage device of the present invention shown in FIG. 1.

FIG. 3 is an isometric view of interacting components of the massage device of the present invention shown in FIGS. 1 and 2, and in particular, a movable finger support member and its mating fixed guide block.

FIG. 4 is an isometric exploded view of a DC motor along with its coupler with offset pin and locking set screw, each of which is a component of the massage device of the present invention shown in FIGS. 1 and 2.

FIG. 5 is an exploded isometric view of a support handle and cover forming components of the massage device of the present invention shown in FIGS. 1 and 2.

FIG. 6 is a partial cutaway isometric view of a flexible cover component of the massage device of the present invention shown in FIGS. 1 and 2.

FIG. 7 are isometric views of a massage device constructed in accordance with a second form of the present invention and having a stabilizing oval or round cover as a component thereof. For purposes of clarity, the larger view within FIG. 7 shows the stabilizing cover partially sectioned to reveal components underneath.

FIG. 8 is an isometric view of a massage device constructed in accordance with a third form of the present invention and having a stepper motor drive mechanism disposed in an alternative orientation to that of the first form of the massage device shown in FIGS. 1 and 2.

FIG. 9 is an exploded isometric view of the massage device of the present invention shown in FIG. 8.

FIG. 9A is an isometric view of one form of a stepper motor used in one or more embodiments of the massage device of the present invention.

FIG. 9B is an isometric view of a driver circuit for use with the stepper motor shown in FIG. 9A.

FIG. 10 is an exploded isometric view of fourth form of the massage device of the present invention.

FIG. 11 is an enlarged isometric view of a portion of the fourth form of the massage device of the present invention shown in FIG. 10.

FIG. 12 is an enlarged isometric view of the geared motor and coupler forming part of the fourth form of the massage device of the present invention shown in FIGS. 10 and 11.

FIG. 13 is an isometric view of a fifth form of the massage device of the present invention.

FIG. 14 is a partially exploded, isometric view of the fifth form of the massage device of the present invention shown in FIG. 13.

FIG. 15 is an isometric view of a possible rubberized covering in place on one of the paddle members of the first through fifth forms of the massage device of the present invention shown in FIGS. 1-14.

FIG. 16 is a partially exploded, isometric view of the covering and paddle member shown in FIG. 15.

FIG. 17 is a top isometric view of the mechanical portion of a massage device constructed in accordance with a sixth form of the present invention.

FIG. 18 is a bottom isometric view of the mechanical portion of the massage device of the present invention shown in FIG. 17.

FIG. 19 is a bottom isometric view of the mechanical portion of the massage device of the present invention shown in FIGS. 17 and 18, and taken at a different viewing angle to that of FIG. 18.

FIG. 20 is a bottom isometric view of the massage device of the present invention which incorporates the mechanical portion thereof shown in FIGS. 17-19 and which further includes a flexible bottom covering.

FIG. 20A is a partially exploded isometric view of a massage device incorporating the mechanical portion shown in FIGS. 17-20, and illustrating other components of the massage device which work in cooperation with the mechanical portion thereof.

FIG. 21 is an exploded, top isometric view of a massage device constructed in accordance with a seventh form of the present invention.

FIG. 22 is a longitudinal cross-sectional depiction of the massage device of the present invention shown in FIG. 21, with the handheld cover thereof shown in transparency to illustrate the mounting of the mechanical portion of the massage device within the handheld cover.

FIG. 23 is a partially cutaway, isometric view of a massage device constructed in accordance with an eighth form of the present invention.

FIG. 24 is another partially cutaway, isometric view of the massage device of the present invention shown in FIG. 23.

FIG. 25 is an exploded, isometric view of the massage device of the present invention shown in FIGS. 23 and 24.

FIG. 26A is a top plan view of the massage device of the present invention shown in FIGS. 23-25.

FIG. 26B is a bottom plan view of the massage device of the present invention shown in FIGS. 23-25.

FIG. 26C is a rear elevational view of the massage device of the present invention shown in FIGS. 23-25.

FIG. 26D is a front elevational view of the massage device of the present invention shown in FIGS. 23-25.

FIG. 26E is a side elevational view of the massage device of the present invention shown in FIGS. 23-25.

FIG. 27 is an isometric view of a mechanical subassembly of the massage device of the present invention shown in FIGS. 23-26E.

FIG. 28 is another isometric view of the mechanical subassembly shown in FIG. 27 of the massage device of the present invention shown in FIGS. 23-27.

FIG. 29 is a longitudinal cross-sectional view of the massage device of the present invention shown in FIGS. 23-28.

FIG. 30 is a series of interrelated, exploded, isometric views of the massage device of the present invention shown in FIGS. 23-29, and illustrating the assembly of components of the massage device into a finished product.

FIG. 31A is an isometric view of a massage stick forming a component of the massage device shown in FIGS. 23-30.

FIG. 31B is a top plan view of the massage stick shown in FIG. 31A and forming a component of the massage device shown in FIGS. 23-30.

FIG. 31C is a bottom plan view of the massage stick shown in FIG. 31A and forming a component of the massage device shown in FIGS. 23-30.

FIG. 31D is an end view of the massage stick shown in FIG. 31A and forming a component of the massage device shown in FIGS. 23-30.

### DETAILED DESCRIPTION OF THE PREFERRED EMBODIMENTS

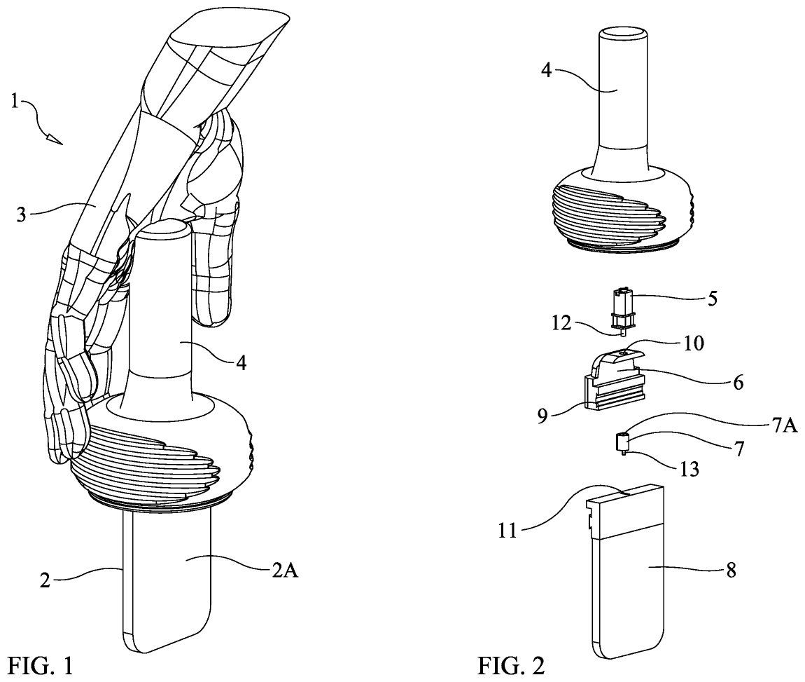

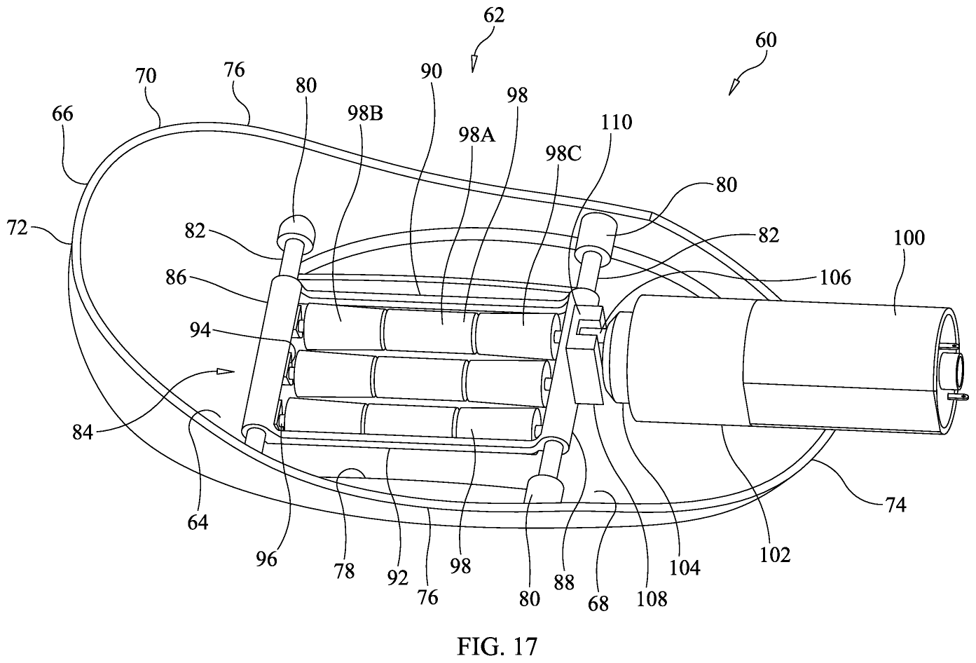

FIG. 1 shows a first embodiment 1 of the massage device of the present invention configured with holding handle 4 and geared DC motor. Hand 3 is shown positioned to grip handle 4. Paddle shaped planar member 2 projects from the bottom of the device and, as will be shown, moves back and forth parallel to the plane of surface 2a. Throughout this description of the massage device(s) of this invention, it is to be understood that various suitably shaped soft rubber coverings will be elastically affixed to paddle member 2 and removable therefrom. This will allow the user to select different cover geometries and colors to suit their preferences. It will also permit removal of the covering for cleaning as necessary. For example, a covering 2b may be in the shape of three human fingers integrally joined together and constructed from a waterproof, body safe, phthalate free and latex free material (see FIGS. 15 and 16 of the drawings).

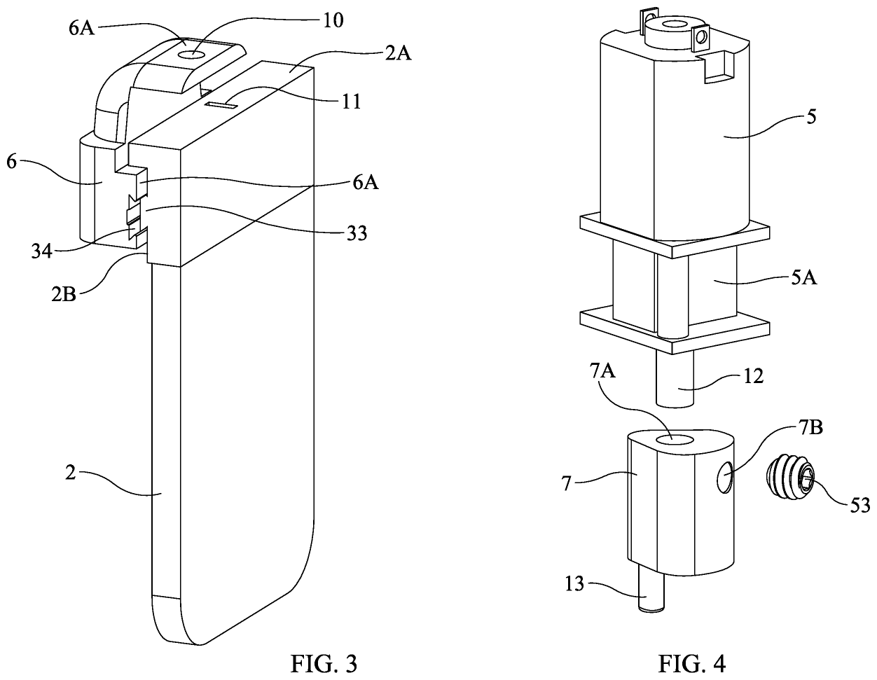

FIG. 2 shows the first embodiment 1 of the massage device in an exploded state. FIGS. 3 and 4 should be viewed for additional clarification. DC motor 5 (with reduction gearbox 5a mounted thereto) is mounted directly to fixed block 6. A suitable geared version of this motor also appears as shown in FIG. 4. Many geared motors with different output shaft RPM's are available but a standard 60 RPM geared motor, providing a paddle movement at 1 Hz, will be satisfactory. Such a motor is readily available for less than about five U.S. dollars. For example, Part No. B07SR7DCFS manufactured by Hxchen of Shenzhen, China is suitable for use as motor 5 with gearbox 5a. The drive shaft 12 of geared DC motor 5 passes through hole 10 in a right angled portion 6a of fixed block 6 overhanging the top surface of movable paddle member 2 and is locked into center hole 7a of coupler 7 by use of set screw 53 which threads into tapped hole 7b of coupler 7. Fixed block 6 is made from a rigid material which can be of zinc diecast alloy or rigid plastic such as Valox® thermoplastic produced by Sabic Corporation of Riyadh, Saudi Arabia. Coupler 7 has eccentric pin 13 extending outwardly therefrom which is positioned offset from hole 7a. Coupler 7 may also be made of zinc diecast material. When motor/gearing shaft 12 turns, this causes coupler 7 to rotate. Eccentric pin 13 follows a circular path and rides in slot 11 of paddle member 2. As coupler member 7 turns on its axis, eccentric pin 13 causes paddle member 2 to move reciprocatingly laterally on fixed block 6. Paddle member 2 may be made from the same material as fixed block 6. Paddle member 2 includes a dovetail-shaped laterally extending male projection 33 extending from an inner side wall of the paddle member 2 at the upper portion thereof, which projection 33 is slidably received in a complementary, dovetail-shaped female track 34 formed in an outer side wall of fixed block 6 which faces the inner side wall of paddle member 2, thus joining the paddle member 2 to fixed block 6 but allowing reciprocating relative movement between member 2 and block 6.

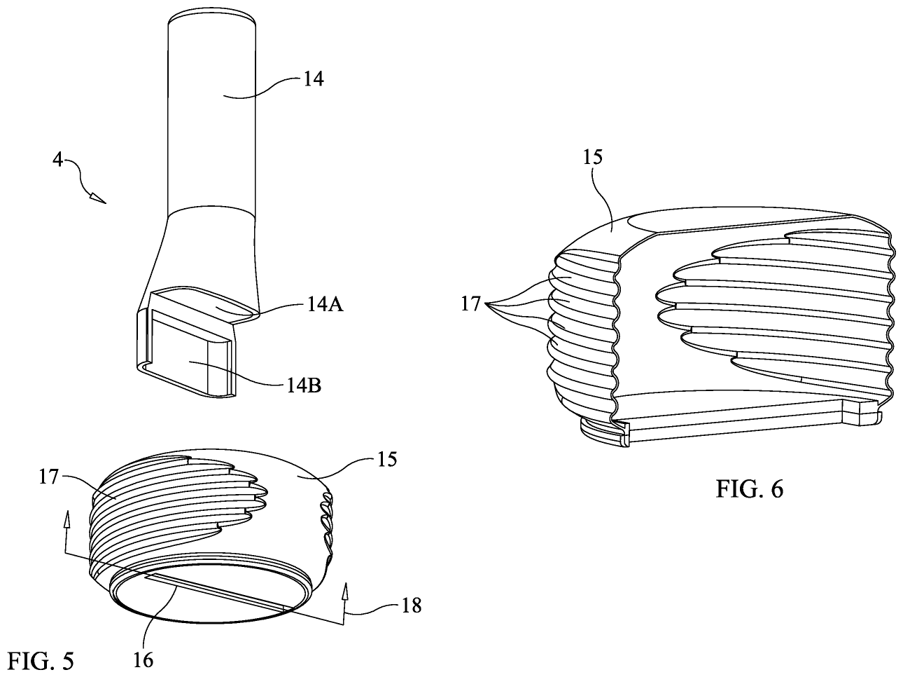

FIG. 5 is an isometric exploded view of a combination cover/handle 4 forming part of the first embodiment 1 of the massage device of the present invention. Reference to FIG. 6 which is a partial cutaway view of cover 15 will further clarify the structure of cover 15. There is a need for one portion (i.e., handle 14) of the cover/handle 4 to be rigid. Rigidity of this part 14 provides a stable surface for mounting the drive components of the massage device 1 and also presents a suitable handle for the user to hold. Handle 14, which may be formed from Delrin or Nylon, or another thermoplastic material, also preferably includes an internal cavity 14a for receiving motor 5, gearbox 5a, batteries for driving the motor, electrical circuitry and an ON/OFF power switch and/or speed control potentiometer mounted on handle 14 to control movement of paddle member 2 and its speed. The generally U-shaped, downwardly extending lower portion 14b of handle 14 is complementary shaped to receive and captively hold fixed block 6 therein. The cover 15, affixed to rigid handle 14, needs to be flexible in order to accommodate relative movement between paddle member 2 and fixed block 6 when the paddle member 2 moves back-and-forth. This flexibility is provided both by the nature of the material used in cover 15 and the partial bellows-type of flexible walls 17 placed as required to allow the needed flexing of this cover member 15. The material used is preferably of low durometer silicone rubber. Manufacture of cover/handle 4 is best accomplished through insert molding (a.k.a. over molding). Here, the rigid handle part 14 would desirably be initially molded from a plastic resin such as Nylon or Delrin. Handle part 14 would then be placed in a suitably designed mold tool and the flexible cover 15 would be then molded to secure handle 14 thereto. The bellows-type walls 17 preferably occupy diametrically opposite positions on cover 15 and are in alignment with the plane of lateral movement of paddle member 2.

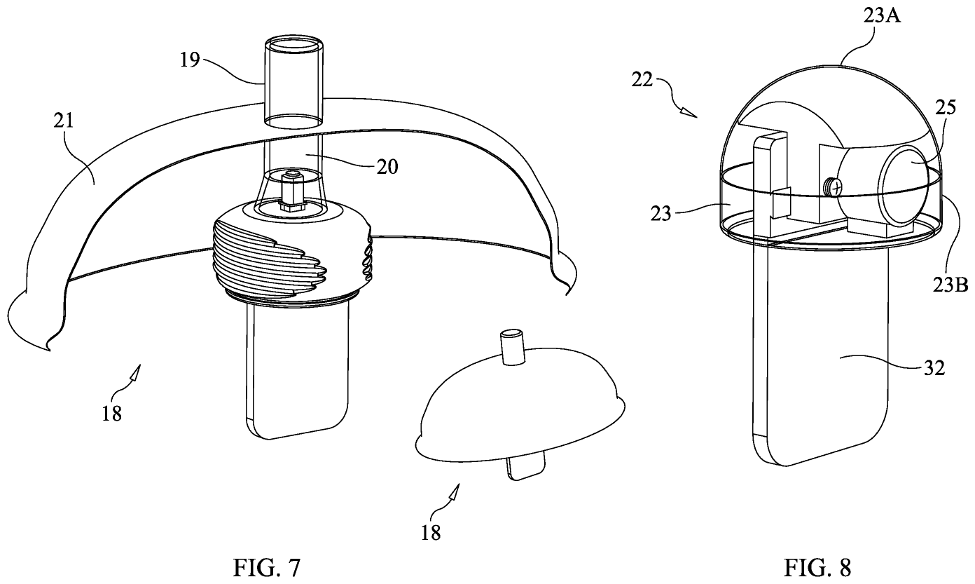

FIG. 7 shows a second embodiment 18 of a massage device formed in accordance with the present invention and incorporating the structure of the first embodiment 1 of the massage device described previously, but without grasping handle 14. In this second embodiment 18, the stabilizing feature thereof is an oval or round shaped cover 21. This design addresses the challenge of providing a stabilizing mechanism which does not rely on inertial effects nor the user's grip on the device. More specifically, the concept in this design is that the geometry of cover 21 would allow it to be rested over the vagina area and provide the needed stabilizing function without need for the user grasping an enlarged handle 14 as in the first embodiment 1 nor reliance on inertial effects. The user may simply lightly hold cover 21 in place to maintain the desired position of the massage device over a body part. The nub 19 extending outwardly from cover 21 includes a bore 20 which may house some of the mechanical and electrical components of the device, such as described previously with the first embodiment 1 of the massage device. Cover 21 is preferably molded from a semi-rigid thermoplastic resin such as Westlake Epolene® N-21 low molecular weight polyethylene.

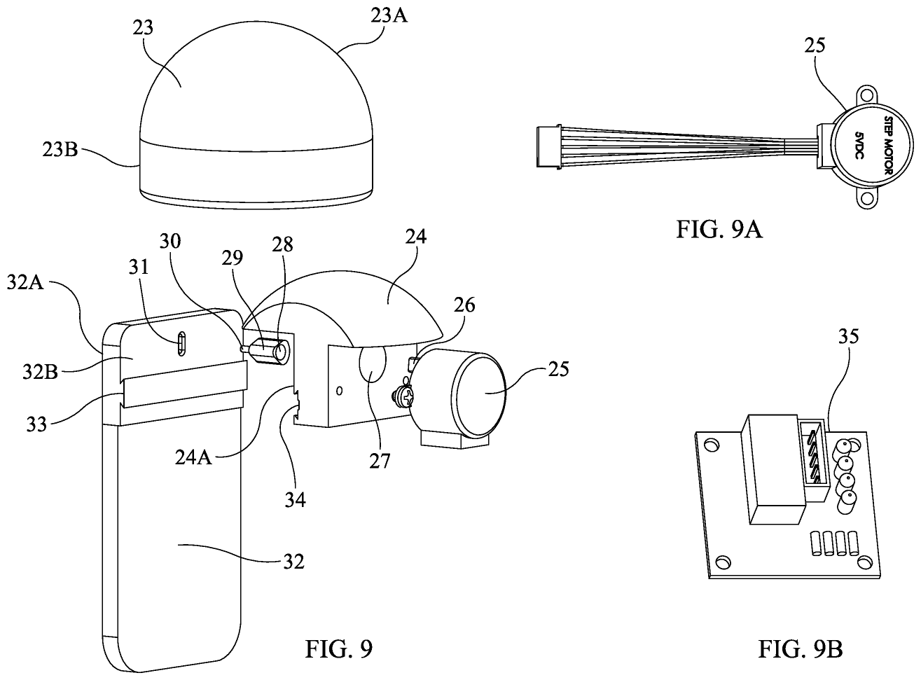

FIG. 8 shows an isometric view of a third embodiment 22 of the massage device of the present invention. This embodiment 22 includes a paddle member 32 which is structured and functions similarly to paddle member 2 but this time it is actuated using a stepper motor 25 (see FIG. 9A). The stepper motor 25 is shown mounted with its axis perpendicular to the paddle member 32, but it could be mounted vertically as shown with the DC gear motor 5 previously in FIG. 2. This orientation is shown both to demonstrate how a different arrangement can be employed in the massage device of the present invention and also how a geared stepper motor 25 could be an alternative drive system. Geared stepper motor 25 is of standard design and suitable units are readily available with matched driving circuit 35 (see FIG. 9B) in small quantities at less than about three U.S. dollars. For example, a Longruner 5X Geared 5 v Stepper Motor 28BYJ 48 Uln2003 coupled with Uln2003 Driver Board with ArduinoIDE, supplied by Oriental Motor Co. Ltd. Of Japan, are suitable for use as a geared stepper motor 25 and driving circuit 35. There are several attractive options provided by use of the geared stepper motor versus geared DC motor. These include the ability to incorporate customized velocity profiles which could be readily modified and accessed by the user using Bluetooth™ technology and a smart phone with suitable software. Stepper motors also provide relatively high torque at low RPM, making them particularly suitable for this application. This third embodiment 22 of the massage device of the present invention also includes a cover 23 which has both a rigid upper portion 23a and a flexible, lower, ring-shaped skirt portion 23b.

FIG. 9 is an exploded isometric view of the components of this third embodiment 22 of the massage device. Cover 23 is hollow inside and provides a concave inner surface to which a rigid block 24 having a convex top surface is bonded. Geared stepper motor 25 is secured to block 24 with its shaft 26 concentric with hole 27 formed through the thickness of the side wall of block 24. Hole 27 is big enough to provide running clearance for eccentric coupler 29 when center bore 28 formed on one side of coupler 29 is mounted to shaft 26 of stepper motor 25. Eccentric coupler 29 has pin 30 extending outwardly from the opposite axial side and is mounted offset from bore 28 such that pin 30 traces a circular path when shaft 26 of motor 25 rotates. Pin 30 is engaged with the elongated slot 31 of paddle member 32 such that the circular path of pin 30 causes paddle member 32 to oscillate linearly, guided by the dovetail male projection 33 formed on a side wall 32a of paddle member 32 sliding within complementary-shaped dovetail female track 34 formed in a side wall 24a of fixed block 24 that faces paddle member side wall 32a. The cover 23 is configured to provide a stabilizing feature, as previously described in the second embodiment 18 of the massage device of the present invention, in that the user may lightly hold and position the cover 23 at its rigid upper portion 23a over a desired body part to be massaged.

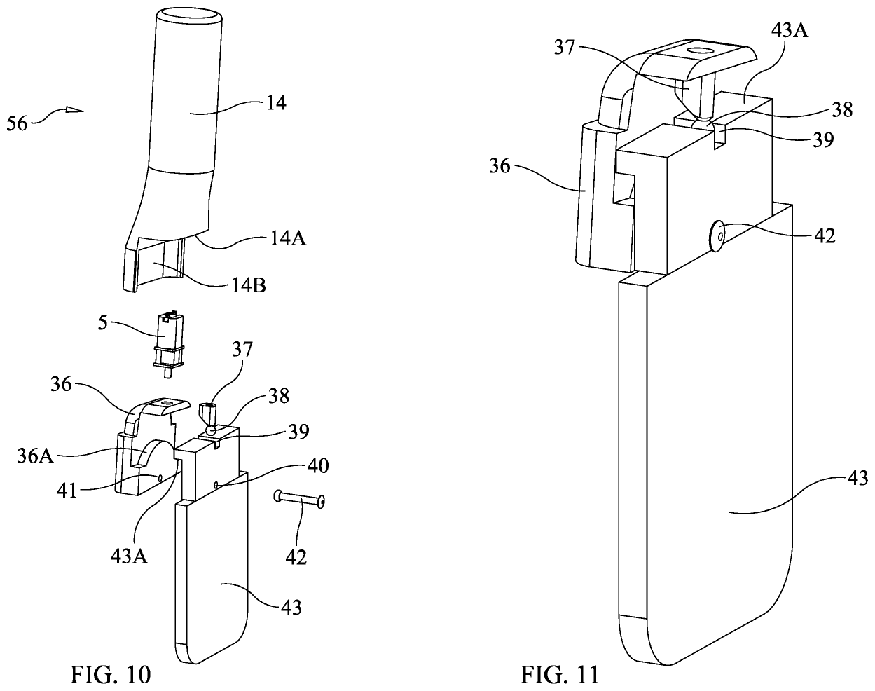

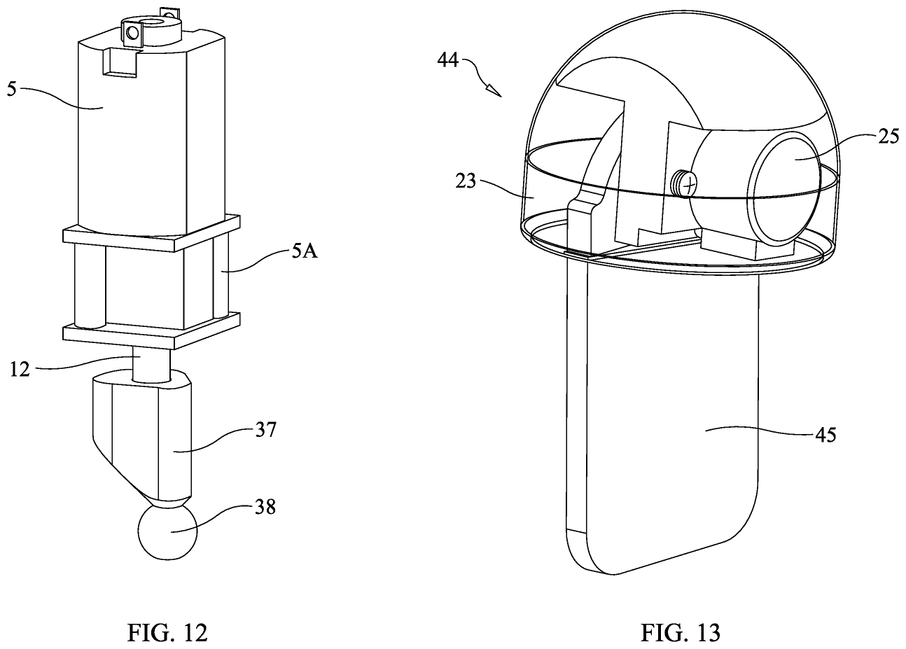

FIG. 10 shows a partially exploded, isometric view of a fourth embodiment 56 of the massage device of the present invention which provides for rotational or swinging movement of the paddle member 43 as opposed to the previously described embodiments 1, 18, 22 which generate linear sliding movement of the paddle member 2, 32. In this embodiment (see also FIGS. 11 and 12), the same geared DC motor 5 as used in the first embodiment 1 and shown in FIG. 2 is mounted to a modified fixed block 36. Attached to the shaft 12 of motor gearbox 5a is a specially formed coupler 37 having a ball shaped end 38. Ball shaped end 38 fits closely into slot 39 formed in the top surface of planar paddle member 43. Paddle member 43 is pivotally connected to fixed block 36 with pop rivet 42, pivot pin, shoulder screw or other fastener, which passes through aligned holes 40 and 41 of paddle member 43 and block 36, respectively. Pop rivet 42 can be Part Number 97447A151 aluminum blind rivet from McMaster-Carr of Elmhurst, Illinois or it can be a similar part from another manufacturer. Assembly of these parts 43, 36 is done such that the pop rivet 42, pivot pin or other fastener is constrained by suitable fixturing to hold the paddle member 43 and fixed block 36 together but allow for pivotal movement of paddle member 43 on fixed block 36 about the rivet 42. Pop rivet 42 is preferably chosen as the means to hold parts 43 and 46 together for several reasons: low unit cost and assembly cost versus a shoulder screw, for example.

Referring back now to FIGS. 10, 11 and 12, it can be seen that when shaft 12 of motor gearbox 5a turns on its axis, coupler 37 also turns and this causes the ball end 38 of coupler 37, received by slot 39, to trace a circular path whose radius is equal to the eccentricity of the coupler geometry. This, in turn, drives the paddle member 43 in a side-to-side, reciprocating motion such that paddle member 43 is caused to pivot on the axis of rivet 42. Coupler 37 is similar in shape to that of coupler 7 of the first embodiment 1 of the massage device of the present invention shown in FIG. 2 but has a ball shaped projection 38 instead of the pin 13 of coupler 7. The necessity for this ball geometry can be appreciated in this instance when one considers the fact that walls of slot 39 tilt away from the vertical when paddle member 43 pivots from side-to-side about the axis of pop rivet 42. The ball projection 38 allows for the side walls defining slot 39 to tilt or displace angularly with respect to block 36 without interference. If straight pin 13 of coupler 7 were to be used here, it would jam within slot 39 as paddle 43 rotates around pop rivet 42. Again referring to FIG. 10, fixed block 36 can be seen to have an arcuate surface 36a. The reason for this shape is to allow the underside surface 43a of the upper, L-shaped portion of paddle member 43 to rock freely back and forth as paddle member 43 oscillates about pop rivet 42, pivotal pin or other fastener.

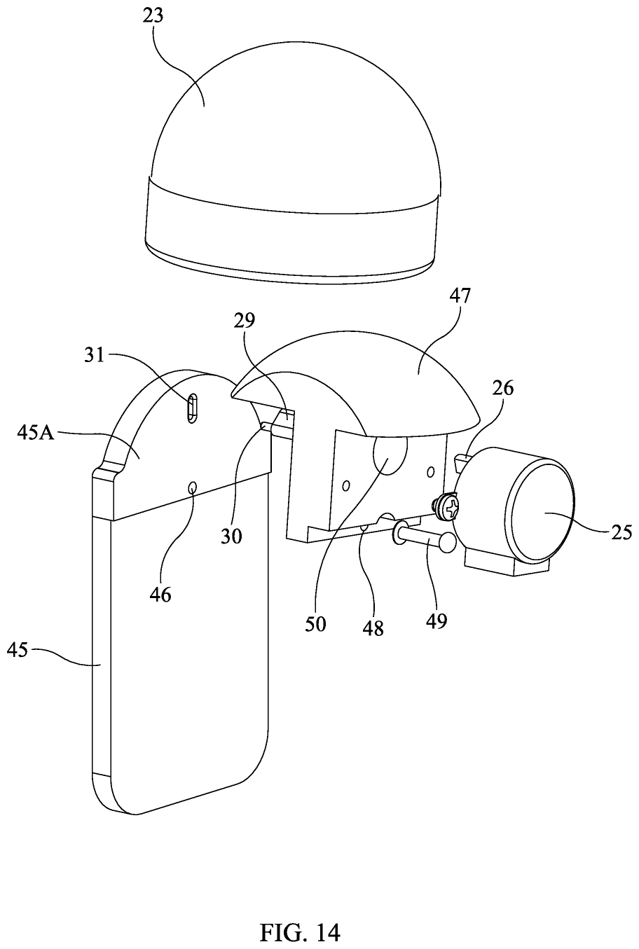

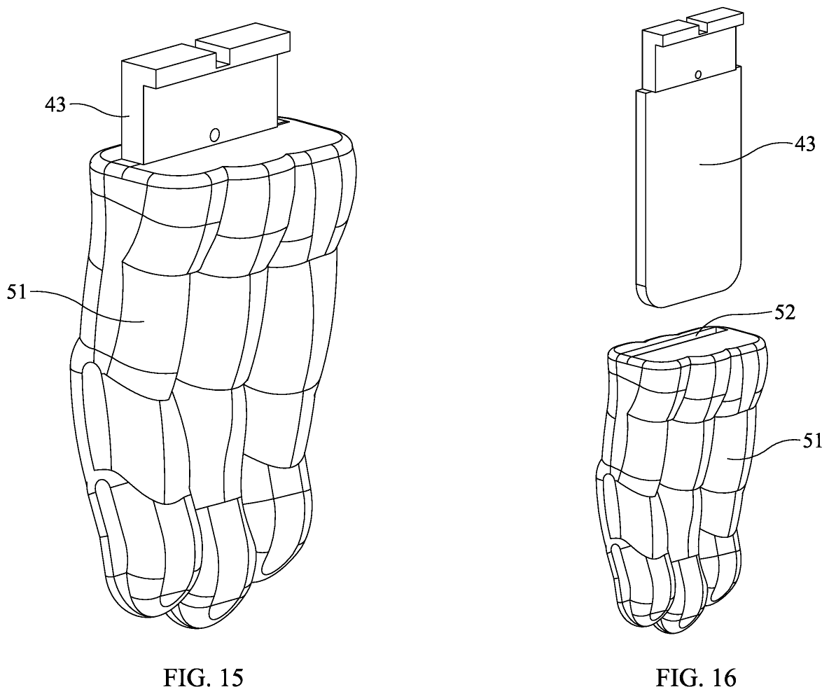

FIG. 13 is an isometric view of a fifth embodiment 44 of the massage device of the present invention. This fifth embodiment 44 is very similar in overall structure and function to that of the second embodiment 22 of the massage device shown in FIGS. 8 and 9 and described previously, except that the fifth embodiment 44 is structured to impart a pivoting motion to paddle member 45 as opposed to the second embodiment 22 in which paddle member 32 moves reciprocatingly laterally. With this fifth embodiment 44 of the massage device of the present invention, the same stepper motor 25 used in the third embodiment 22 is mounted to a fixed block 47 which is different in shape in some respects from fixed block 24 of the second embodiment 22. More specifically, fixed block 47 differs from fixed block 24 by having no sliding dovetail feature 34 but instead incorporates a rotational axis hole 48. Likewise, paddle member 45 does away with the dovetail geometry of fixed block 24 in favor of rotational axis hole 46. These features may be seen in FIG. 14, which is a partially exploded isometric view of the fifth embodiment 44 of the massage device. The same coupler 29 with its eccentrically located pin 30 is attached to shaft 26 of geared stepper motor 25, as in the second embodiment 22. Shaft 26 passes through hole 50 of fixed block 47 before being secured to coupler 29. Pop rivet 49, pivot pin or other fastener which allows relative pivotal movement between block 47 and member 45 is received by aligned holes 46 and 48 respectively formed in paddle member 45 and fixed block 47 to join paddle member 45 and fixed block 47 together but to allow paddle member 45 to pivot on fixed block 47 about the axis of rivet 49. Pin 30 of coupler 29 fits into slot 31 of paddle member 45, and when the motor 25 is actuated, this pin 30, moving in a circular path and traveling within the confines of slot 31, causes paddle member 45 to reciprocatingly pivot on fixed block 47 about rivet 49. Accordingly, the paddle member 45 is driven to swing back and forth about the common axis of holes 46 and 48 and rivet 49.

Throughout this description of the various embodiments of the massage device of this invention, as previously described, it is to be understood that various suitably shaped soft rubber coverings will be elastically affixed to paddle members 2, 32, 43 and 45 as shown in the drawings. FIG. 15 shows one possible covering configuration 51 with paddle member 43 (as an example) inserted therein and into a slot 52 formed in the top surface of the covering 51. FIG. 17 is a partially exploded view of the covering 51 and paddle member 43 shown in FIG. 16, wherein the paddle member 43 has been withdrawn from slot 52 which is integrally molded in covering 51.

Reference should now be had to FIGS. 17-20 of the drawings, which illustrate a sixth embodiment of the massage device 60 constructed in accordance with the present invention. In this embodiment, a mechanism 62 for providing a lateral massaging motion to a desired body part of the user is mounted within a cavity 64 defined by a base plate 66. More specifically, the base plate 66 is preferably in the form of an oblong-shaped member having a lower wall 68 which extends to a side wall 70 that is joined to the lower wall 68. The side wall 70 is joined to the lower wall 68 and extends upwardly therefrom, and further may take on different heights relative to the lower wall 68 as it surrounds the lower wall 68. For example, at the front 72 of the base plate 66, the side wall 70 may be higher relative to the lower wall 68 than it is at the rear 74 of the base plate 66, and may have a height relative to the lower wall 68 over portions of the opposite lateral sides 76 of the base plate 66, as can be seen in FIG. 17 of the drawings. Preferably, the base plate 66 is made from a rigid or semi-rigid plastic material.

A window 78, preferably rectangular in shape, is formed through the thickness of the lower wall 68 of the base plate 66 to expose therethrough certain components of the mechanism 62 which provide a massaging motion to a desired body part of the user of the device 60. The mechanism 62 for generating this massaging motion will now be described.

There are preferably four bosses 80 joined to the side wall 70 of the base plate 66 and extending outwardly from the inner wall of the side wall 70 on opposite lateral sides 76 of the base plate 66. More specifically, two spaced apart bosses 80 extending outwardly from the inner wall of the side wall 70 at one lateral side 76 of the base plate 66, and two bosses 80 extending outwardly from the inner wall of the side wall 70 at the opposite lateral side 76 of the base plate 66 are provided. The bosses 80 extend into the interior cavity 64 defined by the base plate 66 and the side wall 70 joined thereto. Each boss 80 has a bore formed centrally therein. The bosses 80 on one lateral side 76 of the base plate 66 are aligned with respective bores on the other lateral side 76 of the base plate 66. Each oppositely disposed pair of bosses 80 receive in their respective bores the axial ends of a fixed slide post 82 such that the slide posts 82 extend from the inner wall of the side wall 70 on one lateral side 76 of the base plate 66 to the inner wall of the side wall 70 on the opposite lateral side 76 of the base plate 66, and are secured in place by the bosses 80.

A movable frame 84 is mounted to and between and, as will be seen, is reciprocatingly slidable on, the slide posts 82. More specifically, the movable frame 84 includes a cylindrical first member 86 and a cylindrical second member 88. Each of the cylindrical first member 86 and cylindrical second member 88 has a bore formed axially therethrough, the inner diameter of the bore being slightly greater than the outer diameter of the fixed slide post 82 on which the cylindrical member 86, 88 is mounted so that a respective fixed slide post 82 may be received by the bore of one of the cylindrical first member 86 and the cylindrical second member 88 of the movable frame 84 and so that the frame 84 is movable reciprocatingly on the fixed slide posts 82.

The movable frame 84 further includes a first side rail 90 and a second side rail 92 situated opposite from and in parallel with the first side rail 90. Each of the first side rail 90 and the second side rail 92 extends from and in between the cylindrical first member 86 and the cylindrical second member 88 of the movable frame 84 and are joined to the cylindrical first and second members 86, 88.

The movable frame 84 may further include mounting brackets 94 affixed to each of the cylindrical first member 86 and the cylindrical second member 88 of the frame 84. Preferably, there are three mounting brackets 94 joined to each of the cylindrical first member 86 and the cylindrical second member 88 of the movable frame 84, such as depicted in FIG. 17 of the drawings; however, one, two or any number of mounting brackets 94 may be provided on each of the cylindrical first member 86 and cylindrical second member 88 of the movable frame 84.

The purpose of the mounting brackets 94 is to support roller rods 96 which extend from the mounting brackets 94 of the cylindrical first member 86 to the mounting brackets 94 of the cylindrical second member 88. Preferably, these roller rods 96 are fixedly joined to the mounting brackets 94 of the cylindrical first member 86 and the cylindrical second member 88, although it is envisioned that the roller rods 96 may also rotate with respect to the mounting brackets 94 on each of the cylindrical first member 86 and the cylindrical second member 88. In an alternative version of the massage device 60 shown in FIGS. 17-20, the mounting brackets 94 may be omitted, and the roller rods 96 may be affixed directly to an outer surface of the cylindrical first member 86 and the cylindrical second member 88 of the movable frame 84. Thus, the roller rods 96 extend between the cylindrical first member 86 and the cylindrical second member 88 and are preferably parallel to one another. Again, like the mounting brackets 94 of the cylindrical first member 86 and the cylindrical second member 88, there may be one, two or several roller rods 96 extending between the cylindrical first member 86 and the cylindrical second member 88, although three roller rods 96 are depicted in the massage device 60 shown in FIGS. 17-20 of the drawings.

Mounted on each roller rod 96 is one or a plurality of rollers 98. Each roller 98 is rotatable on its respective roller rod 96. As depicted in FIG. 17 of the drawings, there are three rollers 98 rotatably mounted on each roller rod 96, although it is envisioned that fewer or greater number of rollers 98 than three are mounted on each roller rod 96.

In a preferred form of the massage device 60, and as shown in FIG. 17 of the drawings, three rollers 98 are rotatably mounted on each of three roller rods 96. More specifically, a series of three rollers 98 is rotatably mounted on each of three roller rods 96, and the rollers 98 of each series of rollers 98 is independently rotatable on its respective roller rod 96. Even more specifically, on each roller rod 96 is mounted a center roller 98a, which is preferably cylindrical in shape, and a pair of end rollers 98b, 98c situated on opposite axial ends of the center roller 98a and adjacent to but independently rotatable with respect to the center roller 98a. Preferably, the end rollers 98b, 98c have a truncated conical (i.e., frustoconical) shape, each having a larger diameter nearer the cylindrical first member 86 or the cylindrical second member 88. The outer surface of each end roller 98b, 98c is tapered so that the diameter of the end roller 98b, 98c over a portion thereof which is proximate the center roller 98a has a diameter which is substantially the same as the diameter of the center roller 98a to which it is adjacent.

Thus, the frame 84 with its cylindrical first member 86 and cylindrical second member 88, and the rollers 98 mounted between the cylindrical first member 86 and the cylindrical second member 88, can move laterally on the base plate 66 within the window 78 formed in the lower wall 68 of the base plate 66, with at least some or all of the rollers 98 extending at least partially through the window 78 as the frame 84 moves reciprocatingly on the fixed slide posts 82 on which it is mounted.

The mechanism 62 for moving the frame 84 within the window 78 of the lower wall 68 of the base plate 66 and on the fixed slide posts 82 will now be explained. As shown in FIG. 17, the massage device 60 includes a motor 100 having a shaft (not shown) which is connected to a speed reduction gearbox assembly 102, also having a shaft (not shown). The shaft of the gearbox assembly 102 is attached to a drive wheel 104. The drive wheel 104 includes an eccentric post 106 extending outwardly from and mounted eccentrically (i.e., off center) on a surface thereof.

There is a rotational movement-to-linear movement translation coupler 108 that is mounted on the cylindrical second member 88 of the frame 84. Preferably, the translation coupler 108 is U-shaped in transverse cross-section so that it defines a slot 110 extending from one end of the translation coupler 108 to an opposite end thereof. The slot 110 is dimensioned to receive the eccentric post 106 of the drive wheel 104 and to allow the eccentric post 106 to move reciprocatingly along at least a portion of the longitudinal length thereof.

When the motor 100 is energized, the gearbox assembly 102 joined thereto provides a reduced velocity and increased torque to the shaft of the gearbox assembly 102 and the drive wheel 104 mounted thereon. The eccentric post 106 is mounted close to the periphery or outer diameter of the drive wheel 104 and will rotate in a circular motion along with the drive wheel 104 when the motor 100 is energized. The eccentric post 106, being received by the slot 110 of the translation coupler 108, will move reciprocatingly within the slot 110. Such movement of the eccentric post 106 as the drive wheel 104 turns will cause the frame 84 to move reciprocatingly on the fixed slide posts 82, since the rotational movement-to-linear movement translation coupler 108 is fixedly mounted on the cylindrical second member 88 of the frame 84. Accordingly, rotational movement of the drive wheel 104 and the eccentric post 106 extending therefrom will be translated to linear, reciprocating movement of the frame 84 on the fixed slide posts 82 within the interior cavity of the base plate 66 and over the window 78 formed in the lower wall 68 of the base plate 66.

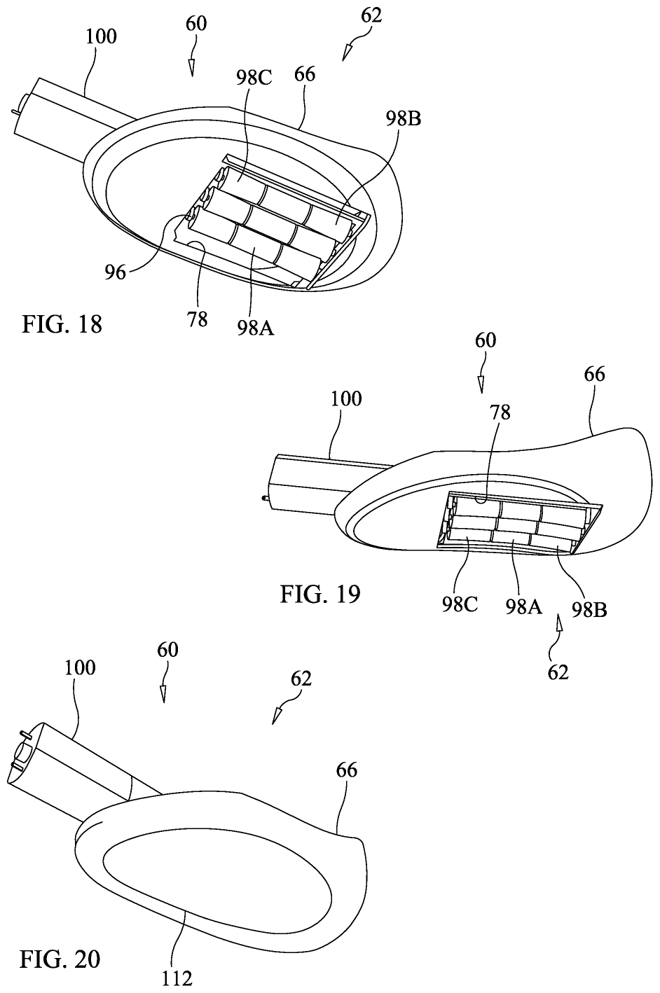

As can be seen in FIGS. 18 and 19 of the drawings, and as mentioned previously, the rollers 98 rotatably mounted on the frame 84 are situated in alignment with the window 78 formed in the lower wall 68 of the base plate 66, and at least a portion of one or more of the rollers 98 on each roller rod 96 projects through the window 78 and below the lower surface of the lower wall 68. Thus, when the motor 100 of the massage device 60 is energized, and the lower surface of the lower wall 68 of the base plate 66 is placed against a body part of the user of the massage device 60, the rollers 98 on the movable frame 84 will move reciprocatingly in a side-to-side motion against the body part as the frame 84 moves reciprocatingly on the fixed slide posts 82 and thus will provide a massaging motion to the body part with which the rollers 98 directly or indirectly come in contact. However, for sanitary purposes it is preferred that the lower surface of the lower wall 68 of the base plate 66 is covered by a thin flexible membrane or cover 112 so that the rollers 98 do not come in direct contact with the user's body part. The membrane 112 provides a hermetic and/or liquidtight seal to the base plate 66, not only for sanitary and safety purposes, but also to eliminate or minimize any need for cleaning the massaging mechanism 62 and rollers 98 of the massage device 60. Because the membrane 112 covering the lower surface of the lower wall 68 of the base plate 66 is preferably thin, the effect of the rollers 98 and lateral movement of the frame 84 will be felt by the user through the thin membrane covering 112. The membrane cover 112 is preferably formed from a body safe, waterproof, phthalate free and latex free material.

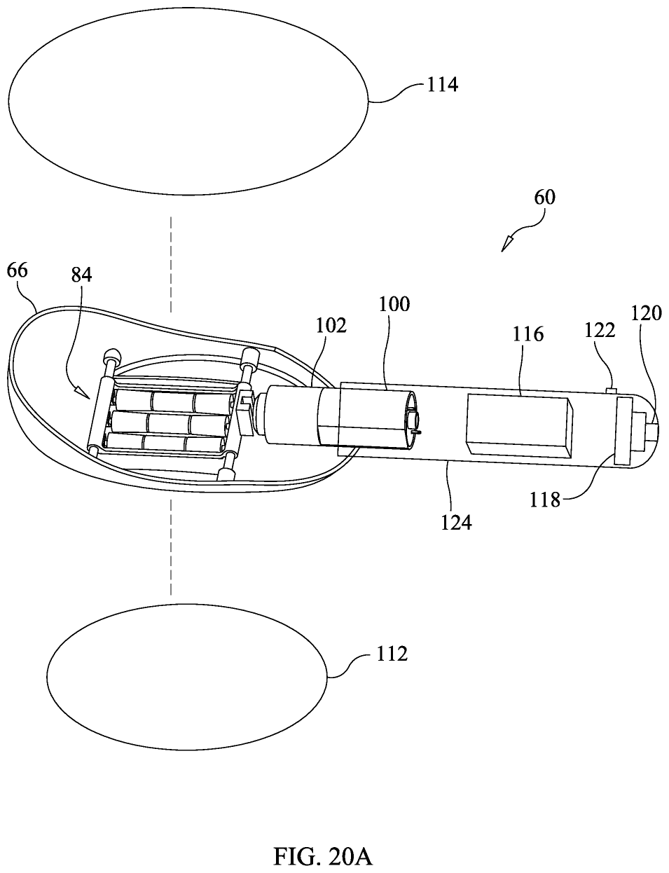

As mentioned previously, what is shown in FIGS. 17-20 is the mechanical portion 62 of a massage device 60 formed in accordance with the present invention. A massage device 60 incorporating the mechanical portion 62 shown in FIGS. 17-20 is depicted in FIG. 20A. More specifically, and as mentioned previously, a thin membrane cover 112 may be affixed to the lower surface of the lower wall 68 of the base plate 66 and covering the window 78 formed therein. A top cover 114 may be joined to or integrally formed with the upper free edge of the side wall 70 of the base plate 66 so as to completely cover the interior cavity 64 of the base plate 66 and to form a hermetic and/or liquidtight seal therewith. The top cover 114 may also be formed from a body safe, waterproof, phthalate free and latex free material.

The massage device 60 shown in FIG. 20A may also include a rechargeable battery 116 which provides power to the motor 100 and which may be arranged to be co-axial with the motor 100, a printed circuit board 118 on which electronic circuitry for operating the massage device 60 and energizing and de-energizing the motor 100, a push button power and control switch 120 mounted on the printed circuit board 118 to control either or both of the energization and de-energization of the motor 100 and the speed of the motor 100 and a charging port 122 for charging the battery 116 and for connection to an external charging module having an electrical cable and plug that is receivable in the charging port 122 (the charging module and associated components are not shown as they are well known in the art). The massage device 60 may also include a tubular, plastic cover 124 having a bore which extends to a closed end, which cover 124 may be fitted over the motor 100 and/or the gearbox assembly 102, the battery 116, the printed circuit board 118 and the power and control switch 120, with the charging port 122 being mounted on a surface of the cover 124. This cover 124 acts as a handle for the user to grasp when using the massage device 60 of the present invention. The closed end of the cover/handle 124 is soft enough for the user to press to actuate the power and control switch 120.

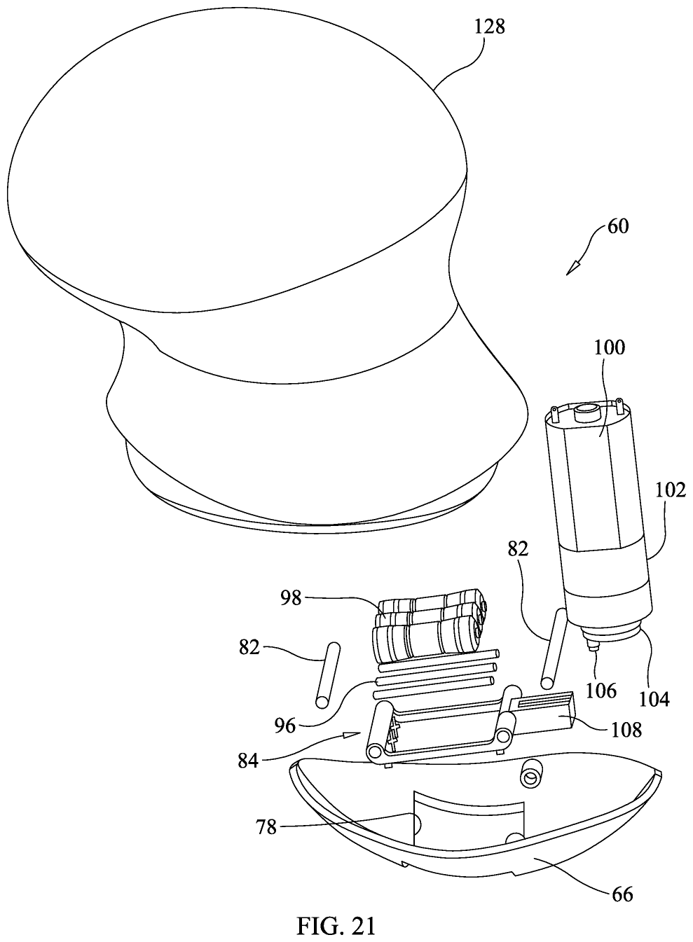

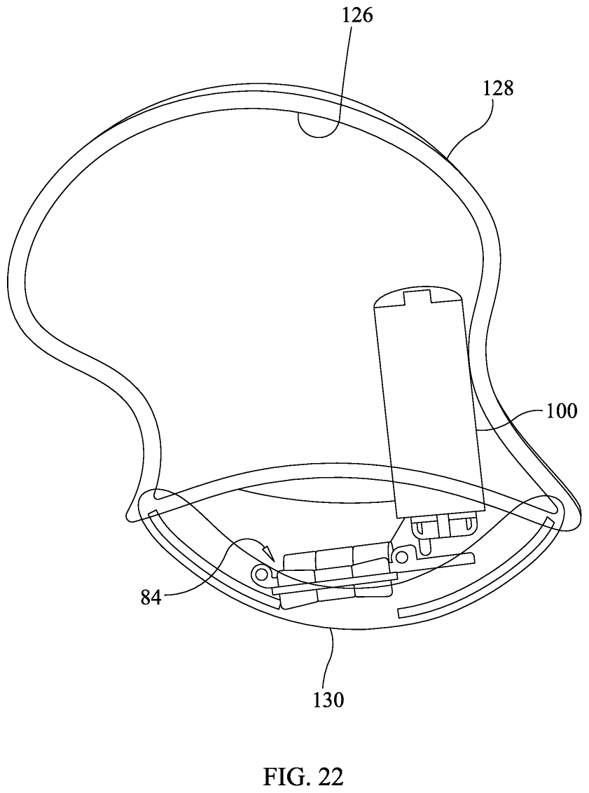

FIGS. 21 and 22 illustrate yet another form of a massage device 60 constructed in accordance with the present invention. This massage device 60 includes much of the mechanical portion 62 illustrated in FIGS. 17-20 of the drawings. In this embodiment of the massage device 60, the motor 100, speed reduction gearbox assembly 102 and drive wheel 104 are co-axially arranged and are substantially perpendicular to the general plane in which the movable frame 84 and its components reside so that the mechanical portion 62 may be fitted into the internal cavity 126 of a top cover or sleeve 128 which acts as a handle for the user to hold when using the massage device 60, as depicted in FIG. 22 of the drawings. In this embodiment, the rotational movement-to-linear movement translation coupler 108 is moved ninety degrees from the way it was situated in the embodiment of the mechanical portion 62 shown in FIGS. 17-20 so that it is essentially co-planar with the general plane in which the movable frame 84 resides, and is attached to the cylindrical second member 88 of the movable frame 84. The eccentric post 106 of the drive wheel 104 is received in the slot 110 of the translation coupler 108 so that, when the motor 100 is energized, the drive wheel 104 will rotate and cause the eccentric post 106 to move reciprocatingly within the slot 110 of the translation coupler 108. The movement of the eccentric post 106 within the slot 110 of the translation coupler 108 will cause the frame 84 to move reciprocatingly on the fixed slide posts 82 mounted on the base plate 66 in the same manner as occurs with the mechanical portion 62 shown in FIGS. 17-20 and described previously. The side wall of the cover/handle 128 at the open end thereof engages the base plate 66 to form a hermetic and/or liquidtight seal therewith, and is sufficiently rigid for the user to grasp when using the massage device 60. A thin membrane bottom cover 130 may be affixed to the lower wall 68 of the base plate 66 to cover the window 78 formed therein and to form a hermetic and/or liquidtight seal therewith. Both the top cover/handle 128 and the bottom cover 130 are preferably made from a body safe, waterproof, phthalate free and latex free material. Within the cavity 126 of the top cover/handle 128 may be situated a printed circuit board 118 (not shown), a power and control switch 120 (not shown) mounted on the printed circuit board 118 and a charging port 122 mounted on the outer surface of the top cover/handle 128, such as shown in FIG. 20A of the massage device 60 of the present invention. Also, a rechargeable battery 116 may be included in the massage device 60 and situated within the cavity 126 of the top cover/handle 128, such as described previously and as will be described herein with further embodiments of the massage device 60 of the present invention.

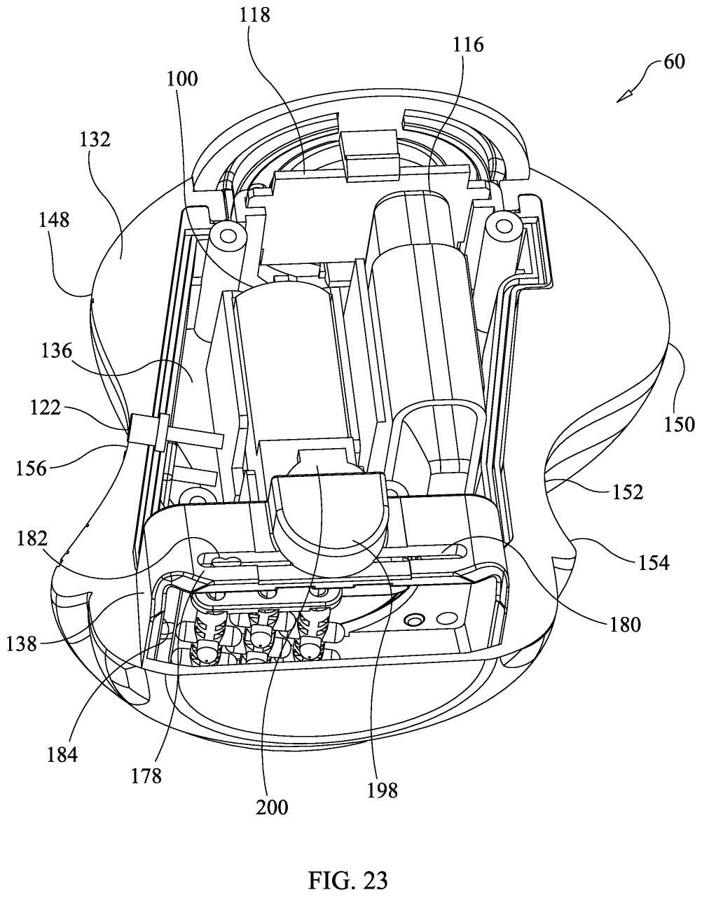

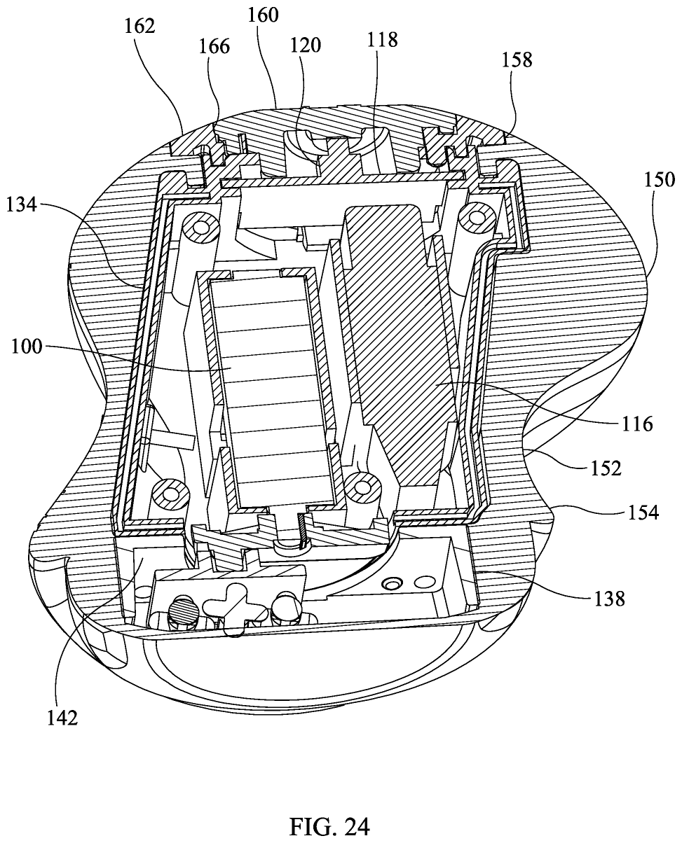

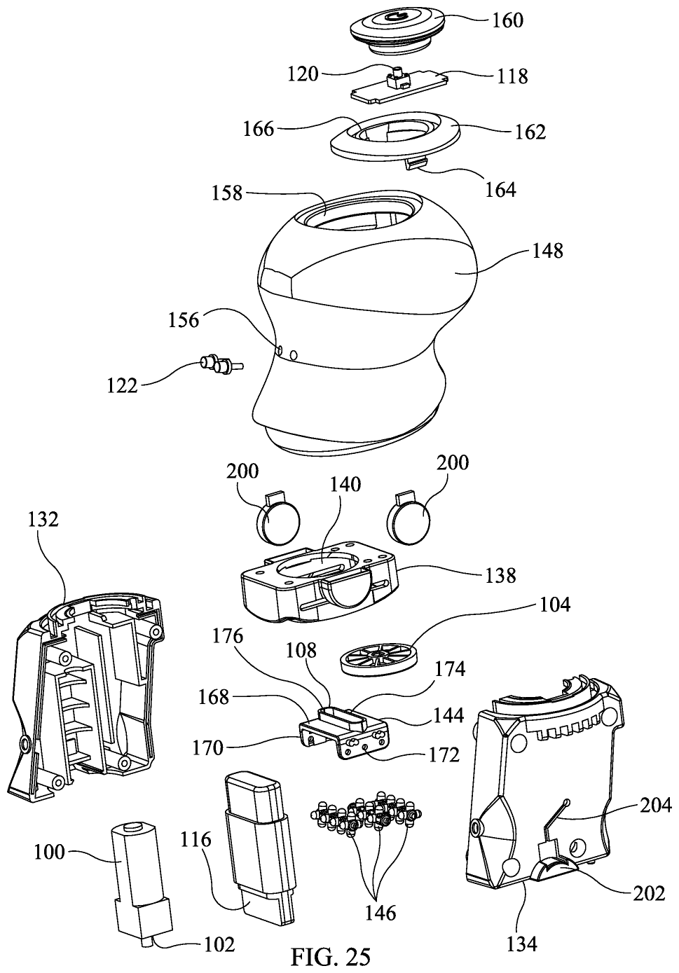

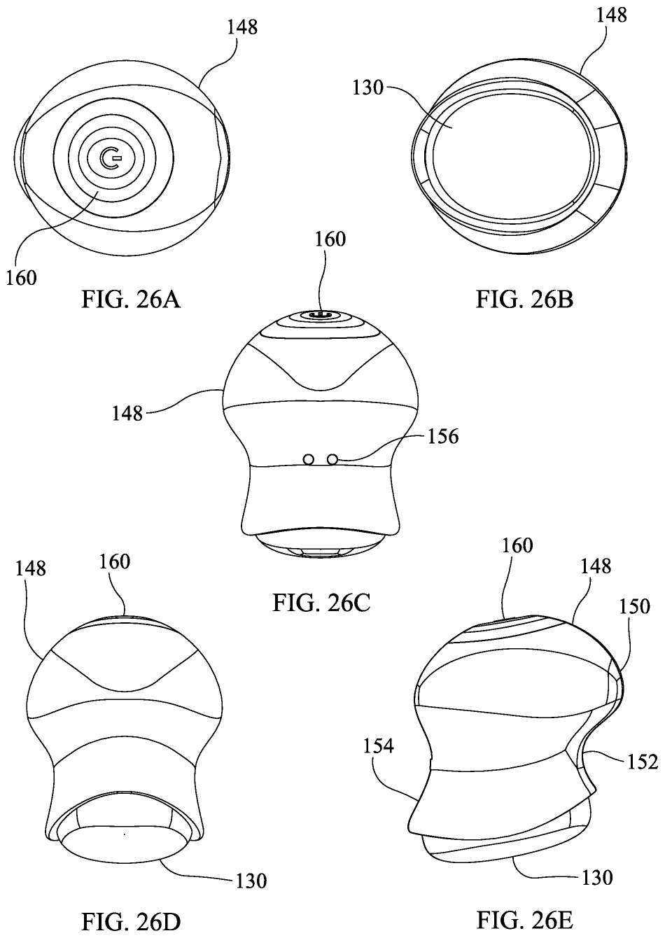

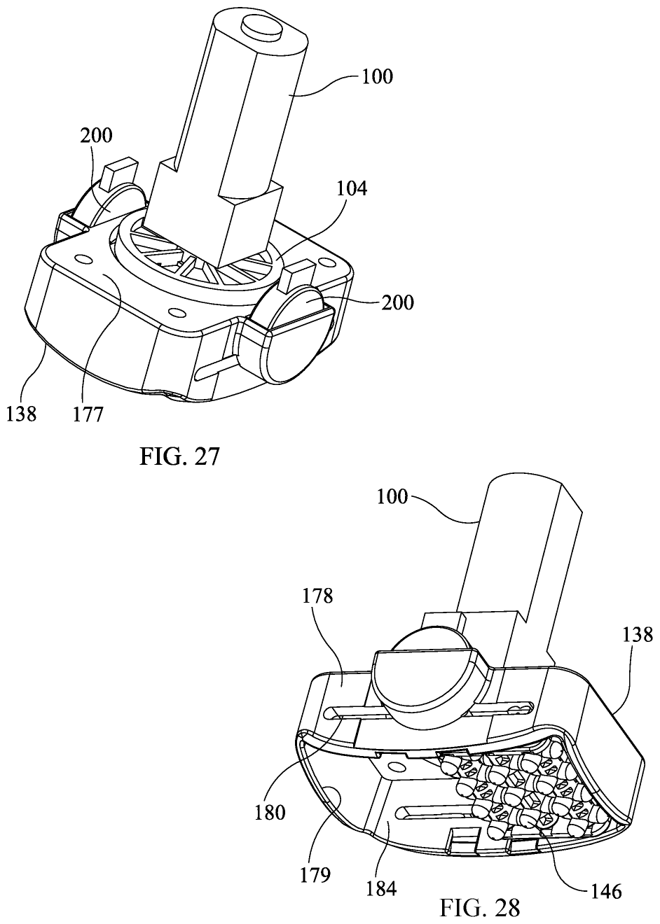

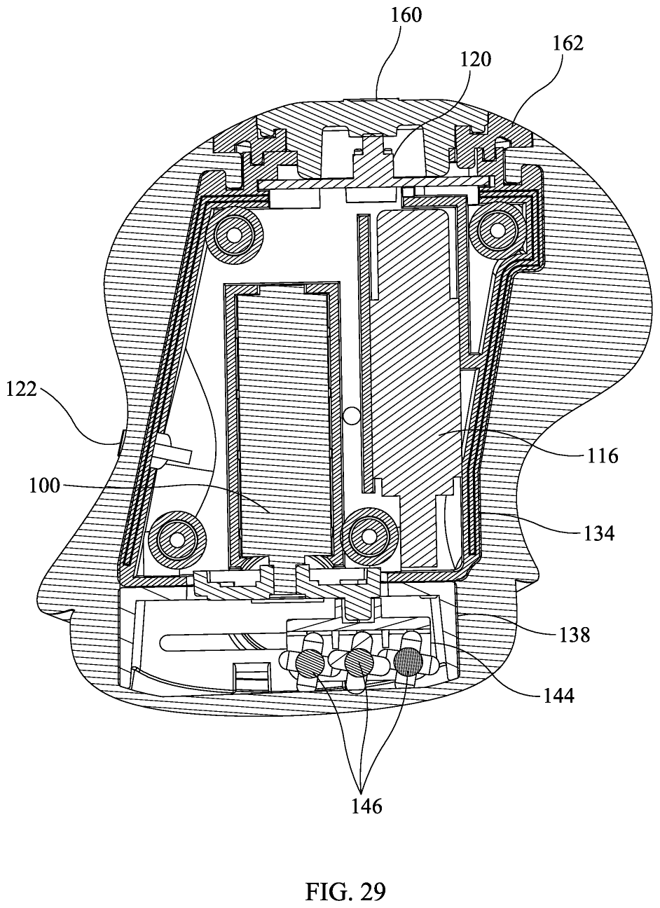

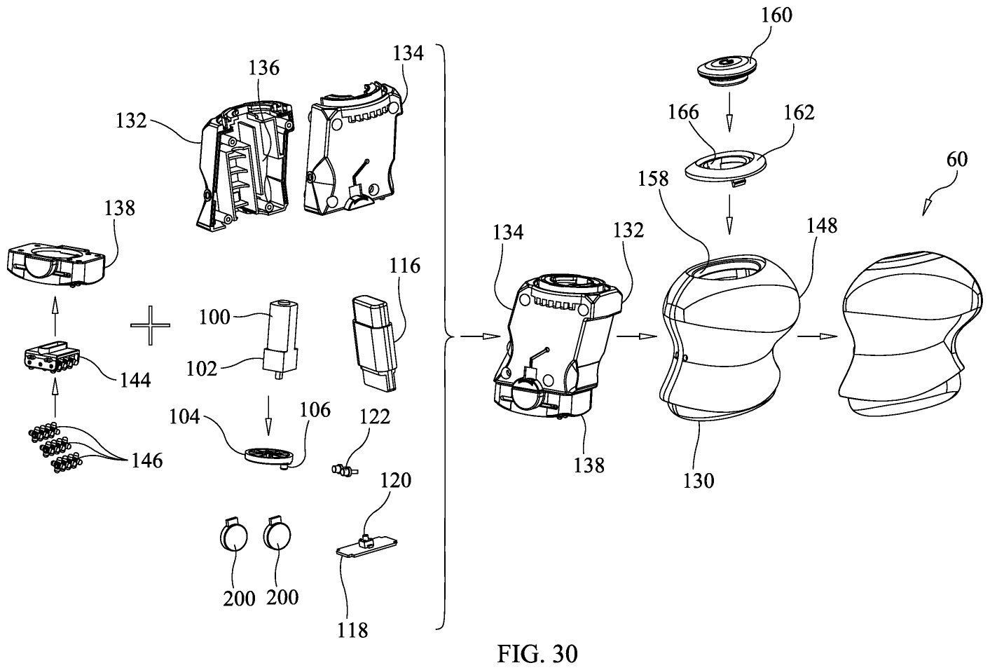

FIGS. 23-31D illustrate another form of a massage device 60 and the components thereof constructed in accordance with the present invention. This massage device 60 works similarly to that of the massage device 60 and mechanical components thereof shown in FIGS. 17-20A.

The massage device 60 includes a first half-housing 132 and a second half-housing 134 which is mated to the first half-housing 132 and affixed thereto using fasteners such as machine screws. The first and second half-housings 132, 134 together define a cavity 136 to hold various components, both electrical and mechanical, of the massage device 60 therein, which components are held in place by various tabs and shelves extending inwardly of the cavity 136 from the interior side walls of the first and second half-housings 132, 134.

Also situated within the cavity 136 and held in place by the first half-housing 132 and the second half-housing 134 are a drive motor 100 and a battery 116. The drive motor 100, in this embodiment, includes a speed reduction gearbox assembly 102 which is integrally joined to the drive motor 100 and includes a shaft extending therefrom. The battery 116 is preferably a rechargeable battery, which is charged by an external power module. A charging port 112 or a pair of charging ports is mounted on an outer surface of a side wall of the first half-housing 132 and, preferably, the second half-housing 134, for charging the battery 116.

Each of the first half-housing 132 and the second half-housing 134 includes a bottom wall to which a movement track housing 138 is mounted when the first half-housing 132 and the second half-housing 134 are joined together. The movement track housing 138 includes a top wall in which a circular opening 140 is formed therethrough. A drive wheel 104 which is mounted to the shaft of the drive motor/gearbox assembly 100, 102 is received by the circular opening 140 formed in the movement track housing 138. The movement track housing 138 defines a cavity 142 therein which houses a movable bracket 144 similar in many respects to the movable frame 84 shown in FIGS. 17-20 and one or more massage sticks 146 rotatably mounted on the bracket 144, each of which will be described in greater detail.

The first half-housing 132 and the second half-housing 134, when mated together, and the movement track housing 138, when mounted on the first half-housing 132 and the second half-housing 134, are substantially encapsulated within a silicone sleeve or covering 148. The silicone sleeve 148 has somewhat of an hourglass shape in transverse cross-section, the upper portion 150 of which having a greater diameter than the middle portion 152 thereof, and a lower portion 154 of which has a greater diameter than the middle portion 152 thereof. The upper portion 150 of the sleeve 148 acts as a handle which is graspable by a user of the massage device 60. A thin membrane lower cover 130 is joined to the lower portion 154 of the sleeve 148 and covers the movement track housing 138 and the one or more massage sticks 146 of the movable bracket 144. As will be explained, the massage sticks 146, when reciprocatingly moved on the movement track housing 138 with the bracket 144, contact the inside surface of the thin membrane lower cover 130 to deform the covering 130 when the massage device 60 is in use, thus providing a massaging motion and feel to a body part to which the massage device 60 comes in contact. One or two openings 156 are formed in the outer surface of the sleeve 148, which are in alignment with the charging port or ports 112 of the first half-housing 132 and/or the second half-housing 134 so that the charging ports 112 are exposed through the openings 156 in the sleeve 148 and can mate with a charging plug of a power module.

Furthermore, the silicone sleeve 148 on the upper portion 150 thereof includes a top opening 158 for receiving a printed circuit board 118 on which is mounted a power and control switch 120, preferably in the form of a push button switch, a flexible silicone switch cover piece 160 situated above the push button switch 120 and a switch trim piece 162. The switch trim piece 162 includes diametrically opposed tabs 164 extending outwardly and downwardly from an outer surface thereof, which tabs 164 engage the first half-housing 132 and the second half-housing 134 to hold the trim piece 162 in place thereon and within the top opening 158 formed in the silicone sleeve 148. The switch trim piece 162 also includes a central opening 166 which receives not only the printed circuit board 118 and the power and control switch 120 mounted thereon but also the flexible silicone switch cover piece 160. The printed circuit board 118 is held in place and mounted to the upper portions of the first half-housing 132 and the second half-housing 134. Thus, the silicone sleeve 148, the flexible switch cover piece 160 and the thin membrane lower cover 130 form an outer shell which encapsulates the mechanical and electrical components of the massage device 60 and which provides a hermetic and/or liquidtight covering for the massage device 60. At least the thin membrane lower cover 130, but more preferably, the entire silicone sleeve 148 and switch cover piece 160, are formed from a waterproof, body safe, phthalate free and latex free material.

The mechanical components of the massage device 60 of this particular embodiment will now be described in greater detail. The drive wheel 104 includes an eccentric post 106 extending outwardly from the lower surface thereof. The drive wheel 104 is centrally mounted to the shaft of the drive motor/speed reduction gearbox assembly 100, 102. The eccentric post 106 is radially disposed away from the center of the drive wheel 104 so that it extends outwardly from the lower surface thereof closer to the periphery of the drive wheel 104.

The bracket 144 of this embodiment of the massage device 60 of the present invention is similar in some respects to the movable frame 84 shown in FIGS. 17-20 of the drawings. The bracket 144 includes a main body having a top wall 168 and two spaced apart lateral walls 170 which are parallel to one another and which extend perpendicularly downwardly from the opposite lateral ends of the top wall 168, which provides the main body of the bracket 144 with a generally U-shaped configuration in transverse cross-section. Each of the lateral walls 170 of the bracket 144 includes one or more openings 172 formed therein, the openings 172 of one lateral wall 170 being aligned with corresponding openings 172 of the other lateral wall 170. These openings 172 receive the axial ends of one or more massage sticks 146, which are rotatable within the openings 172 and on the bracket 144.

Similar to the mechanical structure of the movable frame 84 shown in FIGS. 17-20, the movable bracket 144 includes a rotational movement-to-linear movement translation coupler 108. The translation coupler 108 is in the form of an elongated boss mounted on and extending outwardly from the top surface of the top wall 168 of the bracket 144, and having a pair of parallelly disposed side walls 174 and, preferably, a pair of opposite end walls 176 joined to the side walls 174, each of the walls 174, 176 extending outwardly from the top surface of the top wall 168 of the bracket 144. The side walls 174, and if included, the end walls 176, define between them or among them an elongated slot 110 which is dimensioned to loosely receive the eccentric post 106 extending from the lower surface of the drive wheel 104. Alternatively, the translation coupler 108 may take the form simply as an elongated slot 110 formed in the top wall 168 of the movable bracket 144 and in which the eccentric post 106 of the drive wheel 104 is received.

The movement track housing includes opposite side walls 178 having formed therein slots 180 extending transversely on the side walls 178 of the movement track housing 138. Each of the lateral walls 170 of the movable bracket 144 includes one, but preferably more than one, pins 182 extending outwardly from the outer surface of the lateral walls 170. These pins 182 are received in corresponding slots 180 formed in the track housing 138 to retain the movable bracket 144 within the track housing 138 but allow the bracket 144 to move reciprocatingly laterally within the interior space 184 defined by the track housing 138. Thus, when the drive motor 100 is energized, it causes the drive wheel 104 to rotate. The eccentric post 106, received within the elongated slot 110 of the translation coupler 108 on the movable bracket 144, causes the bracket 144 to move reciprocatingly on the movement track housing 138.

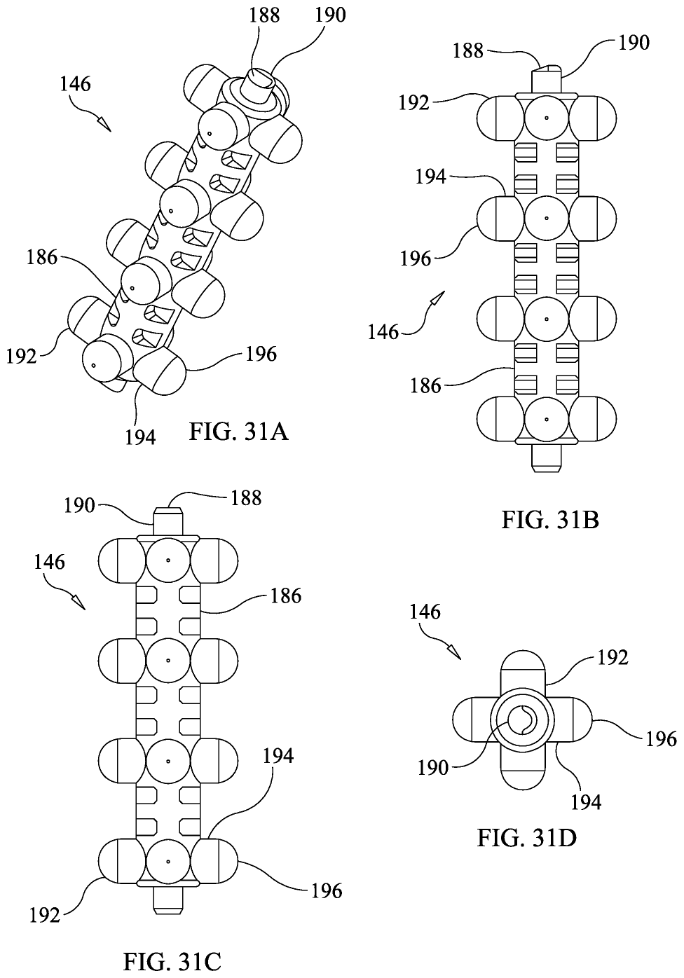

The massage sticks 146, and preferably there are three massage sticks 146 used in this embodiment of the massage device 60 of the present invention, are shown in more detail in FIGS. 31A-31D. Each massage stick 146 includes a cylindrical main body 186 having opposite axial ends and from which opposite pins 188 extend. Alternatively, the cylindrical body 186 of each massage stick 146 includes a central bore for receiving a rod 190, like roller rods 96 of the earlier-described embodiment, on which the massage stick 146 is rotatably mounted. The rod 190 has an axial length which is greater than the axial length of the cylindrical main body 186 of the massage stick 146 so that the rod 190 extends beyond the opposite axial ends of the cylindrical main body 186. The axial ends of the rods 190 are received by the openings 172 formed in the opposite lateral walls 170 of the main body of the movable bracket 144 and are either rotatable in the openings 172 or are affixed to the lateral walls 170 of the movable bracket 144, with the cylindrical main bodies 186 of the massage sticks 144 being rotatable on the rods 190 on which the massage sticks 146 are mounted.

Each massage stick 146 includes a plurality of spaced apart, raised spherical pillars 192. More specifically, each spherical pillar 192 is formed as a cylindrical post 194 having a semicircular free end 196. Preferably, there are four sets of spherical pillars 192 spaced from each other along the axial length of the cylindrical main body 186 of each massage stick 146 and extending radially outwardly from the outer surface of the cylindrical main body 186 of massage stick 146. Each set includes four spherical pillars 190, adjacent pillars 190 of each set being spaced apart circumferentially on the cylindrical main body 186 of the massage stick 146 by ninety degrees. In other words, each set of spherical pillars 190 includes a first pair of diametrically opposed pillars 190 and a second pair of diametrically opposed pillars 190. The massage sticks 146 are positioned on the movable bracket 144, and the movable bracket 144 is positioned on the movement track housing 138 such that the semicircular free ends 196 of the pillars 190 are capable of engaging the inner surface of the thin membrane bottom cover 130 of the outer sleeve 148 of the massage device 60 when the bracket 144 moves reciprocatingly laterally on the track housing 138, causing the thin membrane cover 130 to deform and to provide a massaging effect to a body part when the user places the bottom of the massage device 60 against his or her skin or body part.

Thus, when the user energizes the drive motor 100 by pressing the push button switch 120 through the flexible switch cover 160, the drive motor 100 rotates the drive wheel 104. The eccentric post 106 of the drive wheel 104, which is received within the elongated slot 110 of the translation coupler 108 on the movable bracket 144, causes the bracket 144 to move reciprocatingly within the track housing 138. As the bracket 144 moves reciprocatingly, the massage sticks 146 rotate and contact the inner surface of the flexible, thin membrane bottom cover 130 of the massage device 60, deforming the cover 130, which is felt by the user when the massage device 60 is placed in contact with the user's skin or body part.

In a preferred form of this embodiment of the massage device 60, the diametrically opposite side walls 178 of the track housing 138 have joined thereto bottom sections 198 of enclosures which at least partially define pockets for at least partially receiving self-contained, vibrating motors 200. Opposite side walls of the first half-housing 132 and the second half-housing 134, at the lower portions thereof, have joined thereto top sections 202 of the enclosures also partially defining the pockets for receiving the vibrating motors 200 so that the vibrating motors 200 are enclosed within the pockets defined by the top enclosure sections 202 and bottom enclosure sections 198 of the track housing 138 and the first half-housing 132 and the second half-housing 134. Wires 204 for energizing the vibrating motors 200 pass through the side walls of the first half-housing 132 and the second half-housing 134 and are electrically coupled to the printed circuit board 118. The vibrating motors 200 provide additional vibrations to the massage device 60 when in use and improves the massage experience.

The operation of the massage device 60 of this embodiment of the present invention will now be further explained. The mechanical moving parts and electrical parts are situated inside the first half-housing 132, the second half-housing 134, the track housing 138 and the silicone sleeve 148. The drive motor 100 drives the drive wheel 104 to rotate, which will drive the bracket 144 to move back and forth along the mechanical movement track (the slots 180) formed in the track housing 138 so that the massage sticks 146 squeeze and roll along the thin layer of the lower cover 130 at the bottom of the silicone sleeve 148 to massage the human body. There are preferably three massage sticks 146 that move back and forth repeatedly, similar to three human fingers. Each massage stick 146 has raised spherical pillars 192. When the bracket 144 moves back and forth repeatedly on the track housing 138, the massage sticks 146 rotate, and the raised spherical pillars 192 will squeeze the thin silicone bottom cover 130 of the massage device 60 and massage the skin or body part to which it comes in contact. The two small button vibration motors 200 will vibrate during this action and improve the massage experience.

Preferably, the drive motor/gearbox assembly 100, 102 is Part No. N30 manufactured by several companies, such as Dongguan Hongxin Liwei Electronic Technology Co., Ltd. of Dongguan, China, and provides a reduced motor speed. The vibrating motors 200 are preferably button-type vibrating motors having Part No. N1234 manufactured by several companies, such as Shenzhen ChuangXinDa Micro Motor Co., Ltd. of Guangdong, China. The vibrating motors 200 will connect to the printed circuit board 118 and will vibrate through the power of the battery 116. The drive motor 100 causes the drive wheel 104 to rotate. The eccentric post 106 of the drive wheel 104 drives the bracket 144 to move on the track housing 138 laterally and reciprocatingly.

The push button switch 120 is mounted on the printed circuit board 118 and controls the operation and energization and de-energization of the massage device 60. The motor 100, the battery 116 and the charging port 122 are electrically coupled to the printed circuit board 118. Preferably, the push button switch 120 is a compound switch such that, if it is pressed and held for three seconds, the drive motor 100 turns on, and if the switch 120 is pressed again or multiple times, the speed of the drive motor 100 may be changed.

The massage device 1, 56, 60 of the present invention will now be further described.

In accordance with a first embodiment of the present invention, such as shown in FIGS. 23-31D, a massage device 60 includes a drive motor 100; a drive wheel 104 operatively coupled to the drive motor 100 to rotate upon energization of the drive motor 100, the drive wheel 104 having an eccentric post 106 situated thereon; a movable bracket 144, the movable bracket 144 including one or more massaging elements 146 rotatably mounted thereon; a rotational movement-to-linear movement translation coupler 108, the translation coupler 108 being operatively coupled to the drive wheel 104 and to the movable bracket 144; and an exterior sleeve 148 defining a handle for a user to hold the massage device 60, the exterior sleeve 148 further defining an interior space in which the drive motor 100, drive wheel 104, movable bracket 144 and rotational movement-to-linear movement translation coupler 108 are disposed; whereby, when the drive motor 100 is energized, the drive motor 100, being operatively coupled to the drive wheel 104, causes the drive wheel 104 to rotate, the rotating drive wheel 104, being operatively coupled to the rotational movement-to-linear movement translation coupler 108, causes the movable bracket 144 and the one or more massaging elements 146 to move with a linear, reciprocating motion.

In this embodiment of the massage device 60, the movable bracket 144 may include a main body having a top wall 168 and opposite lateral walls 170 joined to the top wall 168. The rotational movement-to-linear movement translation coupler 108 is mounted on or forms a portion of the top wall 168 of the main body of the movable bracket 144 and defines an elongated slot 110 in which the eccentric post 106 of the drive wheel 104 is received.

In the massage device 60 described above, the one or more massaging elements 146 include at least one massage stick 146, the at least one massage stick 146 extending between the lateral walls 170 of the main body of the movable bracket 144 and being rotatable relative to the movable bracket 144.

The at least one massage stick 146 of the massage device 60 includes a cylindrical main body 186 having an outer surface and a plurality of spherical pillars 192 extending radially outwardly from the outer surface of the cylindrical main body 186.

In the massage device 60, each spherical pillar 192 preferably includes a post 194 joined to the outer surface of the cylindrical main body 186 of the at least one massage stick 146, the post 194 having a free end 196 formed with a semi-spherical shape.

In the massage device 60, the movable bracket 144 preferably includes at least one rod 190 mounted to and extending between the lateral walls 170 of the main body of the movable bracket 144; and wherein the cylindrical main body 186 of the at least one massage stick 146 has a bore formed axially therethrough, the at least one rod 190 being received by the bore of the cylindrical main body 186 of the at least one massage stick 146 such that the at least one massage stick 146 is rotatably mounted on the at least one rod 190.

The massage device 60 may further include a first housing section 132 and a second housing section 134, the second housing section 134 being joined to the first housing section 132, the first housing section 132 and the second housing section 134, when joined together, defining a cavity 136 therebetween, at least the drive motor 100 being disposed within the cavity 136 defined by the joined together first housing section 132 and the second housing section 134, the first housing section 132 and the second housing section 134 being disposed within the interior space defined by the exterior sleeve 148.

The massage device 60 may further include a rechargeable battery 116, the rechargeable battery 116 being disposed within the cavity 136 defined by the joined together first housing section 132 and the second housing section 134.

The massage device 60 of the present invention may further include a lower track housing 138, the lower track housing 138 including a top wall 177, an open bottom 179 situated opposite the top wall 177, and side walls 178 extending between the open bottom 179 and top wall 177, the top wall 177 and side walls 178 of the lower track housing 138 defining an interior space 184 in which the movable bracket 144 and the rotational movement-to-linear movement translation coupler 108 are disposed, the movable bracket 144 and the at least one massage stick 146 being movable reciprocatingly on the lower track housing 138 and within the interior space 184 thereof, the lower track housing 138 being disposed within the interior space defined by the exterior sleeve 148.

In the massage device 60 described above, the lower track housing 138 is preferably joined to the joined together first housing section 132 and the second housing section 134.

The top wall 177 of the lower track housing 138 of the massage device 60 preferably has formed therein an opening 140, wherein the drive wheel 104 extends into the opening 140 formed in the top wall 177 of the lower track housing 138.

The massage device 60 of the present invention may further include at least one vibrating motor 200, the at least one vibrating motor 200 being at least partially mounted on one of the side walls 178 of the lower track housing 138.

In the massage device 60 described above, the lower track housing 138 may include structure 198 joined to the at least one of the side walls 178 of the lower track housing 138, the structure 198 defining a pocket for at least partially receiving the at least one vibrating motor 200.

In the massage device 60 of the present invention, the exterior sleeve 148 preferably includes a flexible bottom cover portion 130, the flexible bottom cover portion 130 covering the open bottom 179 of the lower track housing 138, the spherical pillars 192 of the at least one massage stick 146 engaging the flexible bottom cover portion 130 and deforming the flexible bottom cover portion 130 outwardly when the bracket 144 and the at least one massage stick 146 move reciprocatingly on the lower track housing 138.

In the massage device 60, each of the lateral walls 170 of the movable bracket 144 preferably includes an outer surface and at least one guide pin 182 extending outwardly from the outer surface; wherein the side walls 178 of the lower track housing 138 include a first side wall 178 and a second side wall 178 disposed opposite the first side wall 178; wherein the first side wall 178 of the lower track housing 138 has formed therein a first guide slot 180, and the second side wall 178 of the lower track housing 138 has formed therein a second guide slot 180, the first guide slot 180 extending transversely across at least a portion of the first side wall 178, and the second guide slot 180 extending transversely across at least a portion of the second side wall 178; and wherein the at least one guide pin 182 of one of the lateral walls 170 of the movable bracket 144 being received by the first guide slot 180 of the first side wall 178 of the lower track housing 138 and being reciprocatingly movable therein, and the at least one guide pin 182 of the other of the lateral walls 170 of the movable bracket 144 being received by the second guide slot 180 of the second side wall 178 of the lower track housing 138 and being reciprocatingly movable therein; whereby reciprocating movement of the movable bracket 144 relative to the lower track housing 138 is guided by the movement of the guide pins 182 within the first guide slot 180 of the first side wall 178 of the lower track housing 138 and within the second guide slot 180 of the second side wall 178 of the lower track housing 138.

In accordance with a second embodiment of the present invention, such as shown in FIGS. 17-22, a massage device 60 includes a drive motor 100; a drive wheel 104 operatively coupled to the drive motor 100 to rotate upon energization of the drive motor 100, the drive wheel 104 having an eccentric post 106 situated thereon; a movable frame 84, the movable frame 84 including one or more massaging elements 98 rotatably mounted thereon; a rotational movement-to-linear movement translation coupler 108, the translation coupler 108 being operatively coupled to the drive wheel 104 and to the movable frame 84; a base plate 66, the base plate 66 including a lower wall 68 and a first side wall portion 70 and a second side wall portion 70, the first side wall portion 70 and the second side wall portion 70 being joined to the lower wall 68 of the base plate 66, the first side wall portion 70 being disposed opposite the second side wall portion 70 on the lower wall 68 of the base plate 66, the lower wall 68 of the base plate 66 having a window 78 formed through the thickness thereof, the movable frame 84 being disposed in alignment with the window 78 formed in the lower wall 68 of the base plate 66, at least a portion of the one or more massaging elements 98 projecting through the window 78 formed in the lower wall 68 of the base plate 66, the lower wall 68, the first side wall portion 70 and the second side wall portion 70 of the base plate 66 defining an interior space 64; and a handle 124 for a user to hold the massage device 60, the handle 124 defining an interior space 126 in which at least the drive motor 100 is at least partially disposed; whereby, when the drive motor 100 is energized, the drive motor 100, being operatively coupled to the drive wheel 104, causes the drive wheel 104 to rotate, the rotating drive wheel 104, being operatively coupled to the rotational movement-to-linear movement translation coupler 108, causing the movable frame 84 and the one or more massaging elements 98 to move with a linear, reciprocating motion.

The massage device 60 as described above, may further include a first slide post 82 and second slide post 82, the second slide post 82 being spaced apart from and disposed in parallel with the first slide post 82, the first slide post 82 and the second slide post 82 being disposed within the interior space 64 of the base plate 66 and extending transversely therein at least partially between the oppositely disposed first side wall portion 70 and the second side wall portion 70; wherein the movable frame 84 is reciprocatingly movable on the first slide post 82 and the second slide post 82 over the window 78 formed in the lower wall 68 of the base plate 66.

In the massage device 60 described above, the movable frame 84 preferably includes a first member 86 and a second member 88, the second member 88 being spaced apart from and disposed in parallel with the first member 86, each of the first member 86 and the second member 88 having a bore formed axially therethrough, the first slide post 82 being received by the bore of the first member 86 of the movable frame 84, and the second slide post 82 being received by the bore of the second member 88 of the movable frame 84.

In the massage device 60 described above, each of the first member 86 and the second member 88 of the movable frame 84 is preferably cylindrical in shape.

In the massage device 60 described above, the movable frame 84 further may include a first side rail 90 and a second rail 92, the second side rail 92 being spaced apart from and disposed in parallel with the first side rail 90, each of the first side rail 90 and the second side rail 92 extending between and being joined to the first member 86 and the second member 88 of the movable frame 84.

In the massage device 60 described above, the movable frame 84 preferably includes at least one rod 96 extending between and operatively joined to the first member 86 and the second member 88 of the movable frame 84, the one or more massaging elements 98 being rotatably mounted on the at least one rod 96.

In the massage device 60 described above, the one or more massaging elements 98 rotatably mounted on the at least one rod 96 of the movable frame 84 are preferably rollers 98.

In the massage device 60 described above, at least one of the rollers 98a, 98b, 98c rotatably mounted on the at least one rod 96 of the movable frame 84 preferably has one of a cylindrical shape and a frustoconical shape.

In the massage device 60 described above, the rotational movement-to-linear movement translation coupler 108 preferably is mounted on one of the first member 86 and the second member 88 of the movable frame 84.

In the massage device 60 of the present invention, the rotational movement-to-linear movement translation coupler 108 preferably includes a main body having an elongated slot 110 formed therein; and wherein the drive wheel 104 includes an axial surface, the eccentric post 106 being mounted on the axial surface and extending outwardly therefrom, the eccentric post 106 of the drive wheel 104 being received by the elongated slot 110 formed in the main body of the rotational movement-to-linear movement translation coupler 108 and reciprocatingly movable therein when the drive motor 100 is energized.

In the massage device 60 of the present invention, the movable frame 84 may generally reside in a plane; and wherein the rotational movement-to-linear movement translation coupler 108 is positioned on the one of the first member 86 and the second member 88 of the movable frame 84 such that the elongated slot 110 of the main body of the rotational movement-to-linear movement translation coupler 108 is disposed to extend substantially perpendicularly to the plane in which the movable frame 84 generally resides.

In the massage device 60 of the present invention, the movable frame 84 may generally reside in a plane; and wherein the rotational movement-to-linear movement translation coupler 108 is positioned on the one of the first member 86 and the second member 88 of the movable frame 84 such that the elongated slot 110 of the main body of the rotational movement-to-linear movement translation coupler 108 is disposed to extend substantially co-planarly with the plane in which the movable frame 84 generally resides.

In the massage device 60 of the present invention, the lower wall 68 of the base plate 66 includes a bottom surface, and the massage device 60 may further include a flexible bottom cover 112 disposed on at least a portion of the bottom surface of the lower wall 68 and covering the window 78 formed through the lower wall 68 of the base plate 66; and wherein the at least portion of the one or more massaging elements 98 which project through the window 78 formed in the lower wall 68 of the base plate 66 engages the flexible bottom cover 112 and deforms a portion of the flexible bottom cover 112 outwardly when the movable frame 84 and the one or more massaging elements 98 move reciprocatingly relative to the base plate 66.

In a massage device 60 formed in accordance with the present invention, the handle 124 may be formed as an exterior sleeve 128, the exterior sleeve 128 defining an interior space 126 in which at least the drive motor 100 and the drive wheel 104 are disposed, the sleeve 128 being joined to the base plate 66.

In accordance with a third embodiment of the present invention, such as shown in FIGS. 1-9B, 15 and 16, a massage device 1, 22 includes a drive motor/gearbox assembly 5, 5a, 25 having a shaft 12, 26 which rotates when the drive motor/gearbox assembly 5, 5a, 25 is electrically energized; a coupler 7, 29 the coupler 7, 29 being operatively coupled to the shaft 12, 26 of the drive motor/gearbox assembly 5, 5a, 25 and being rotatable when the drive motor/gearbox assembly 5, 5a, 25 is electrically energized, the coupler 7, 29 having a coupler wall, and an eccentric pin 13, 30 mounted on the coupler wall and extending outwardly therefrom; a fixed block 6, 24 the drive motor/gearbox assembly 5, 5a, 25 being mounted on the fixed block 6, 24 the fixed block 6, 24 having a block wall 6a, 24a; a paddle member 2, 32, the paddle member 2, 32 being movably mounted on the fixed block 6, 24 the paddle member 2, 32 having a first paddle wall 2a, 32a and a second paddle wall 2b, 32b, one of the first paddle wall 2a, 32a and the second paddle wall 2b, 32b having an elongated slot 11, 31 formed therein, the eccentric pin 13, 30 of the coupler 7, 29 being received by the elongated slot 11, 31 of the paddle member 2, 32 and being reciprocatingly movable therein when the drive motor/gearbox assembly 5, 5a, 25 is electrically energized, the second paddle wall 2b, 32b facing the block wall 6a, 24a of the fixed block 6, 24; and a handle 4, 23, the handle 4, 23 being mechanically coupled to the fixed block 6, 24 and being provided for a user of the massage device 1, 22 to grasp when using the massage device 1, 22; wherein the massage device 1, 22 further includes a track 34 formed transversely in one of the block wall 6a, 24a of the fixed block 6, 24 and the second paddle wall 2b, 32b of the paddle member 2, 32, and a projection 33 mounted on and extending outwardly from the other of the block wall 6a, 24a of the fixed block 6, 24 and the second paddle wall 2b, 32b of the paddle member 2, 32, the projection 33 being received by the track 34 and being reciprocatingly movable therein when the drive motor/gearbox assembly 5, 5a, 25 is electrically energized; whereby, when the drive motor/gearbox assembly 5, 5a, 25 is electrically energized, the drive motor/gearbox assembly 5, 5a, 25, being operatively coupled to the coupler 7, 29, causes the paddle member 2, 32 to move relative to the fixed block 6, 24 with a linear, reciprocating motion.

The massage device 1, 22 of the present invention, may further include a covering 51, the covering 51 being mounted on the paddle member 2, 32.

In the massage device 1, 22 described above, the covering 51 is may be removable from the paddle member 2, 32.

In the massage device 1, 22 described above, the covering 51 is preferably in the shape of one or more human fingers.

In accordance with a fourth embodiment of the present invention, such as shown in FIGS. 10-16, a massage device 56, 44 includes a drive motor/gearbox assembly 5, 5a, 25 having a shaft 12, 26 which rotates when the drive motor/gearbox assembly 5, 5a, 25 is electrically energized; a coupler 37, 29, the coupler 37, 29 being operatively coupled to the shaft 12, 26 of the drive motor/gearbox assembly 5, 5a, 25 and being rotatable when the drive motor/gearbox assembly 5, 5a, 25 is electrically energized, the coupler 37, 29 having a coupler wall, and an eccentric member 38, 30 mounted on the coupler wall and extending outwardly therefrom; a fixed block 36, 47, the drive motor/gearbox assembly 5, 5a, 25 being mounted on the fixed block 36, 47; a paddle member 43, 45, the paddle member 43, 45 being movably mounted on the fixed block 36, 47, the paddle member 43, 45 having a paddle wall 43a, 45a, the paddle wall 43a, 45a having an elongated slot 39, 31 formed therein, the eccentric member 38, 30 of the coupler 37, 29 being received by the elongated slot 39, 31 of the paddle member 43, 45 and being reciprocatingly movable therein when the drive motor/gearbox assembly 5, 5a, 25 is electrically energized; and a handle 14, 23, the handle 14, 23 being mechanically coupled to the fixed block 36, 47 and being provided for a user of the massage device 56, 44 to grasp when using the massage device 56, 44; wherein the massage device 56, 44 further includes a pivot fastener 42, 49, the pivot fastener 42, 49 joining the paddle member 43, 45 to the fixed block 36, 47 such that the paddle member 43, 45 is pivotally mounted on the fixed block 36, 47 and pivotable thereon when the drive motor/gearbox assembly 5, 5a, 25 is electrically energized; whereby, when the drive motor/gearbox assembly 5, 5a, 25 is electrically energized, the drive motor/gearbox assembly 5, 5a, 25, being operatively coupled to the coupler 37, 29, causes the paddle member 43, 45 to move relative to the fixed block 36, 47 with a pivotal, reciprocating motion.

In a massage device 56, 44 such as described above, the eccentric member 38, 30 of the coupler 37, 29 may have at least a portion thereof formed with a spherical shape.

A massage device 56, 44 of the present invention may further include a covering 51, the covering 51 being mounted on the paddle member 43, 45.

In the massage device 56, 44 of the present invention, the covering 51 is preferably removable from the paddle member 43, 45.

In the massage device 56, 44 of the present invention, the covering 51 is preferably in the shape of one or more human fingers.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A massage device, which comprises:
a drive motor;
a drive wheel operatively coupled to the drive motor to rotate upon energization of the drive motor, the drive wheel having an eccentric post situated thereon;
a movable bracket, the movable bracket including one or more massaging elements rotatably mounted thereon;
a rotational movement-to-linear movement translation coupler, the translation coupler being operatively coupled to the drive wheel and to the movable bracket; and
an exterior sleeve defining a handle for a user to hold the massage device, the exterior sleeve further defining an interior space in which the drive motor, drive wheel, movable bracket and rotational movement-to-linear movement translation coupler are disposed;
whereby, when the drive motor is energized, the drive motor, being operatively coupled to the drive wheel, causes the drive wheel to rotate, the rotating drive wheel, being operatively coupled to the rotational movement-to-linear movement translation coupler, causes the movable bracket and the one or more massaging elements to move with a linear, reciprocating motion.

2. A massage device as defined by claim 1, wherein the movable bracket includes a main body having a top wall and opposite lateral walls joined to the top wall; and
wherein the rotational movement-to-linear movement translation coupler is mounted on or forms a portion of the top wall of the main body of the movable bracket and defines an elongated slot in which the eccentric post of the drive wheel is received.

3. A massage device as defined by claim 2, wherein the one or more massaging elements include at least one massage stick, the at least one massage stick extending between the lateral walls of the main body of the movable bracket and being rotatable relative to the movable bracket.

4. A massage device as defined by claim 3, wherein the at least one massage stick includes a cylindrical main body having an outer surface and a plurality of spherical pillars extending radially outwardly from the outer surface of the cylindrical main body.

5. A massage device as defined by claim 4, wherein each spherical pillar includes a post joined to the outer surface of the cylindrical main body of the at least one massage stick, the post having a free end formed with a semi-spherical shape.

6. A massage device as defined by claim 4, wherein the movable bracket includes at least one rod mounted to and extending between the lateral walls of the main body of the movable bracket; and
wherein the cylindrical main body of the at least one massage stick has a bore formed axially therethrough, the at least one rod being received by the bore of the cylindrical main body of the at least one massage stick such that the at least one massage stick is rotatably mounted on the at least one rod.

7. A massage device as defined by claim 4, which further comprises:
a first housing section and a second housing section, the second housing section being joined to the first housing section, the first housing section and the second housing section, when joined together, defining a cavity therebetween, at least the drive motor being disposed within the cavity defined by the joined together first housing section and the second housing section, the first housing section and the second housing section being disposed within the interior space defined by the exterior sleeve.

8. A massage device as defined by claim 7, which further comprises:
a rechargeable battery, the rechargeable battery being disposed within the cavity defined by the joined together first housing section and the second housing section.

9. A massage device as defined by claim 7, which further comprises:
a lower track housing, the lower track housing including a top wall, an open bottom situated opposite the top wall, and side walls extending between the open bottom and top wall, the top wall and side walls of the lower track housing defining an interior space in which the movable bracket and the rotational movement-to-linear movement translation coupler are disposed, the movable bracket and the at least one massage stick being movable reciprocatingly on the lower track housing and within the interior space thereof, the lower track housing being disposed within the interior space defined by the exterior sleeve.

10. A massage device as defined by claim 9, wherein the lower track housing is joined to the joined together first housing section and the second housing section.

11. A massage device as defined by claim 9, wherein the top wall of the lower track housing has formed therein an opening; and
wherein the drive wheel extends into the opening formed in the top wall of the lower track housing.

12. A massage device as defined by claim 9, which further comprises:
at least one vibrating motor, the at least one vibrating motor being at least partially mounted on one of the side walls of the lower track housing.

13. A massage device as defined by claim 12, wherein the lower track housing includes structure joined to the at least one of the side walls of the lower track housing, the structure defining a pocket for at least partially receiving the at least one vibrating motor.

14. A massage device as defined by claim 9, wherein the exterior sleeve includes a flexible bottom cover portion, the flexible bottom cover portion covering the open bottom of the lower track housing, the spherical pillars of the at least one massage stick engaging the flexible bottom cover portion and deforming the flexible bottom cover portion outwardly when the bracket and the at least one massage stick move reciprocatingly on the lower track housing.

15. A massage device as defined by claim 9, wherein each of the lateral walls of the movable bracket includes an outer surface and at least one guide pin extending outwardly from the outer surface;
wherein the side walls of the lower track housing include a first side wall and a second side wall disposed opposite the first side wall;
wherein the first side wall of the lower track housing has formed therein a first guide slot, and the second side wall of the lower track housing has formed therein a second guide slot, the first guide slot extending transversely across at least a portion of the first side wall, and the second guide slot extending transversely across at least a portion of the second side wall; and
wherein the at least one guide pin of one of the lateral walls of the movable bracket being received by the first guide slot of the first side wall of the lower track housing and being reciprocatingly movable therein, and the at least one guide pin of the other of the lateral walls of the movable bracket being received by the second guide slot of the second side wall of the lower track housing and being reciprocatingly movable therein;
whereby reciprocating movement of the movable bracket relative to the lower track housing is guided by the movement of the guide pins within the first guide slot of the first side wall of the lower track housing and within the second guide slot of the second side wall of the lower track housing.

16. A massage device, which comprises:
a drive motor;
a drive wheel operatively coupled to the drive motor to rotate upon energization of the drive motor, the drive wheel having an eccentric post situated thereon;
a movable frame, the movable frame including one or more massaging elements rotatably mounted thereon;
a rotational movement-to-linear movement translation coupler, the translation coupler being operatively coupled to the drive wheel and to the movable frame;
a base plate, the base plate including a lower wall and a first side wall portion and a second side wall portion, the first side wall portion and the second side wall portion being joined to the lower wall of the base plate, the first side wall portion being disposed opposite the second side wall portion on the lower wall of the base plate, the lower wall of the base plate having a window formed through the thickness thereof, the movable frame being disposed in alignment with the window formed in the lower wall of the base plate, at least a portion of the one or more massaging elements projecting through the window formed in the lower wall of the base plate, the lower wall, the first side wall portion and the second side wall portion of the base plate defining an interior space; and
a handle for a user to hold the massage device, the handle defining an interior space in which at least the drive motor is at least partially disposed;
whereby, when the drive motor is energized, the drive motor, being operatively coupled to the drive wheel, causes the drive wheel to rotate, the rotating drive wheel, being operatively coupled to the rotational movement-to-linear movement translation coupler, causing the movable frame and the one or more massaging elements to move with a linear, reciprocating motion.

17. A massage device as defined by claim 16, which further comprises:
a first slide post and second slide post, the second slide post being spaced apart from and disposed in parallel with the first slide post, the first slide post and the second slide post being disposed within the interior space of the base plate and extending transversely therein at least partially between the oppositely disposed first side wall portion and the second side wall portion;
wherein the movable frame is reciprocatingly movable on the first slide post and the second slide post over the window formed in the lower wall of the base plate.

18. A massage device as defined by claim 17, wherein the movable frame includes a first member and a second member, the second member being spaced apart from and disposed in parallel with the first member, each of the first member and the second member having a bore formed axially therethrough, the first slide post being received by the bore of the first member of the movable frame, and the second slide post being received by the bore of the second member of the movable frame.

19. A massage device as defined by claim 18, wherein each of the first member and the second member of the movable frame is cylindrical in shape.

20. A massage device as defined by claim 18, wherein the movable frame further includes a first side rail and a second rail, the second side rail being spaced apart from and disposed in parallel with the first side rail, each of the first side rail and the second side rail extending between and being joined to the first member and the second member of the movable frame.

21. A massage device as defined by claim 18, wherein the movable frame includes at least one rod extending between and operatively joined to the first member and the second member of the movable frame, the one or more massaging elements being rotatably mounted on the at least one rod.

22. A massage device as defined by claim 21, wherein the one or more massaging elements rotatably mounted on the at least one rod of the movable frame are rollers.

23. A massage device as defined by claim 22, wherein at least one of the rollers rotatably mounted on the at least one rod of the movable frame has one of a cylindrical shape and a frustoconical shape.

24. A massage device as defined by claim 18, wherein the rotational movement-to-linear movement translation coupler is mounted on one of the first member and the second member of the movable frame.

25. A massage device as defined by claim 24, wherein the rotational movement-to-linear movement translation coupler includes a main body having an elongated slot formed therein; and
wherein the drive wheel includes an axial surface, the eccentric post being mounted on the axial surface and extending outwardly therefrom, the eccentric post of the drive wheel being received by the elongated slot formed in the main body of the rotational movement-to-linear movement translation coupler and reciprocatingly movable therein when the drive motor is energized.

26. A massage device as defined by claim 25, wherein the movable frame generally resides in a plane; and
wherein the rotational movement-to-linear movement translation coupler is positioned on the one of the first member and the second member of the movable frame such that the elongated slot of the main body of the rotational movement-to-linear movement translation coupler is disposed to extend substantially perpendicularly to the plane in which the movable frame generally resides.

27. A massage device as defined by claim 25, wherein the movable frame generally resides in a plane; and
wherein the rotational movement-to-linear movement translation coupler is positioned on the one of the first member and the second member of the movable frame such that the elongated slot of the main body of the rotational movement-to-linear movement translation coupler is disposed to extend substantially co-planarly with the plane in which the movable frame generally resides.

28. A massage device as defined by claim 16, wherein the lower wall of the base plate includes a bottom surface; and
wherein the massage device further comprises:
a flexible bottom cover disposed on at least a portion of the bottom surface of the lower wall and covering the window formed through the lower wall of the base plate; and
wherein the at least portion of the one or more massaging elements which project through the window formed in the lower wall of the base plate engages the flexible bottom cover and deforms a portion of the flexible bottom cover outwardly when the movable frame and the one or more massaging elements move reciprocatingly relative to the base plate.

29. A massage device as defined by claim 16, wherein the handle is formed as an exterior sleeve, the exterior sleeve defining an interior space in which at least the drive motor and the drive wheel are disposed, the sleeve being joined to the base plate.

30. A massage device, which comprises:
a drive motor/gearbox assembly having a shaft which rotates when the drive motor/gearbox assembly is electrically energized;
a coupler, the coupler being operatively coupled to the shaft of the drive motor/gearbox assembly and being rotatable when the drive motor/gearbox assembly is electrically energized, the coupler having a coupler wall, and an eccentric pin mounted on the coupler wall and extending outwardly therefrom;
a fixed block, the drive motor/gearbox assembly being mounted on the fixed block, the fixed block having a block wall;
a paddle member, the paddle member being movably mounted on the fixed block, the paddle member having a first paddle wall and a second paddle wall, one of the first paddle wall and the second paddle wall having an elongated slot formed therein, the eccentric pin of the coupler being received by the elongated slot of the paddle member and being reciprocatingly movable therein when the drive motor/gearbox assembly is electrically energized, the second paddle wall facing the block wall of the fixed block; and
a handle, the handle being mechanically coupled to the fixed block and being provided for a user of the massage device to grasp when using the massage device;
wherein the massage device further includes a track formed transversely in one of the block wall of the fixed block and the second paddle wall of the paddle member, and a projection mounted on and extending outwardly from the other of the block wall of the fixed block and the second paddle wall of the paddle member, the projection being received by the track and being reciprocatingly movable therein when the drive motor/gearbox assembly is electrically energized;
whereby, when the drive motor/gearbox assembly is electrically energized, the drive motor/gearbox assembly, being operatively coupled to the coupler, causes the paddle member to move relative to the fixed block with a linear, reciprocating motion.

31. A massage device as defined by claim 30, which further comprises:
a covering, the covering being mounted on the paddle member.

32. A massage device as defined by claim 31, wherein the covering is removable from the paddle member.

33. A massage device as defined by claim 31, wherein the covering is in the shape of one or more human fingers.

34. A massage device, which comprises:
a drive motor/gearbox assembly having a shaft which rotates when the drive motor/gearbox assembly is electrically energized;
a coupler, the coupler being operatively coupled to the shaft of the drive motor/gearbox assembly and being rotatable when the drive motor/gearbox assembly is electrically energized, the coupler having a coupler wall, and an eccentric member mounted on the coupler wall and extending outwardly therefrom;
a fixed block, the drive motor/gearbox assembly being mounted on the fixed block;
a paddle member, the paddle member being movably mounted on the fixed block, the paddle member having a paddle wall, the paddle wall having an elongated slot formed therein, the eccentric member of the coupler being received by the elongated slot of the paddle member and being reciprocatingly movable therein when the drive motor/gearbox assembly is electrically energized; and
a handle, the handle being mechanically coupled to the fixed block and being provided for a user of the massage device to grasp when using the massage device;
wherein the massage device further includes a pivot fastener, the pivot fastener joining the paddle member to the fixed block such that the paddle member is pivotally mounted on the fixed block and pivotable thereon when the drive motor/gearbox assembly is electrically energized;
whereby, when the drive motor/gearbox assembly is electrically energized, the drive motor/gearbox assembly, being operatively coupled to the coupler, causes the paddle member to move relative to the fixed block with a pivotal, reciprocating motion.

35. A massage device as defined by claim 34, wherein the eccentric member of the coupler has at least a portion thereof formed with a spherical shape.

36. A massage device as defined by claim 34, which further comprises:
a covering, the covering being mounted on the paddle member.

37. A massage device as defined by claim 36, wherein the covering is removable from the paddle member.

38. A massage device as defined by claim 36, wherein the covering is in the shape of one or more human fingers.
